(19) United States
(12) Patent Application Publication
(10) Pub. No.: US 2013/0325665 A1
(43) Pub. Date: Dec. 5, 2013

(54) SYSTEM, METHOD AND DEVICE HAVING TEACHING AND COMMERCE SUBSYSTEMS

(71) Applicants: Alexandra V. Shaffer, Brooklyn, NY (US); Jonathan B. Santamaria, Asbury, NJ (US)

(72) Inventors: Alexandra V. Shaffer, Brooklyn, NY (US); Jonathan B. Santamaria, Asbury, NJ (US)

(21) Appl. No.: 13/963,747

(22) Filed: Aug. 9, 2013

Related U.S. Application Data
(63) Continuation of application No. 13/469,722, filed on May 11, 2012.
(60) Provisional application No. 61/485,652, filed on May 13, 2011.

(51) Int. Cl. G06Q 30/06; G06Q 50/20

(52) U.S. Cl. CPC G06Q 30/0601; G06Q 50/20
USPC 705/26.61; 705/26.1

(57) ABSTRACT

A system, method and device have teaching and commerce subsystems. The system, in one embodiment, enables building of educational items, teaching with the educational items and marketing of the educational items.

### PRIORITY CLAIM

This application is a continuation-in-part of, and claims the benefit and priority of, U.S. patent application Ser. No. 13/469,722, filed on May 11, 2012, which claims the benefit and priority of U.S. Provisional Patent Application Ser. No. 61/485,652, filed on May 13, 2011. The entire contents of such applications are hereby incorporated by reference.

### COPYRIGHT NOTICE

A portion of the disclosure of this patent document contains or may contain material which is subject to copyright protection. The copyright owner has no objection to the photocopy reproduction by anyone of the patent document or the patent disclosure in exactly the form it appears in the Patent and Trademark Office patent file or records, but otherwise reserves all copyrights whatsoever.

### BACKGROUND

Effective, interactive online teaching, learning, curriculum design and administration have been cumbersome, non-intuitive and costly. There are few purely cloud based applications that are simple to use from a course design, course delivery and administrative perspective. Moreover there are even fewer e-teaching platforms that facilitate human to human interactive teaching. Current approaches are often beyond the economic, technical and administrative reach for many business and teaching institutions that lack sophisticated IT departments or sufficient funding to design and administer online interactive programs. In addition, larger, non-academic enterprises have little means of self-contained, easily editable, interactive teaching/knowledge transfer platforms which are infinitely expandable and can track and store data.

Online learning platforms are traditionally cumbersome to use from the administrative and teaching user interfaces, as well as the process delivered to the learner. While a content management system exists in many platforms allowing for some flexibility in content delivered to the user, platforms generally lack the ability to provide an intuitive process for the course designer which permits person to person interaction and an intuitive, guided process for the learner to review content, complete exercises and interact one-on-one with their teacher. This lack of process around course design, delivery, and learning experience makes current online learning platforms difficult to implement from many aspects.

Another, more involved problem revolves around using technology in the form of web based platforms to facilitate the same interactive teaching and learning process that takes place in a traditional brick and mortar classroom; the interactive relationships between the teacher and the learner and between one learner and another. Prior art platforms require relationships to revolve around a developed course. For example, a teacher designs a course and is responsible for teaching a “classroom” of students who are assigned to the course, but lacks the means to interact in a group or one-on-one in emulation of what is known as the Socratic method or its 20^{th} century descendant the Harkness method. Another example of that which inhibits the teacher student relationship is the rote memorization, static nature of many online platforms.

There is a need for a learning platform that allows for easy language translations within the content management system and user profiles. There is also a need for more cost effectiveness via less IT involvement (hence expense) in customization of learning platform design, course content creation and feature implementation, for programs of any size. This requires a logical presentation of the end user process within the content management system that the course designer or teacher uses, as well as the correct tools to easily upload multimedia content and deliver the desired learning outcomes via a relationally nuanced teaching processes to the learner.

Furthermore, many teachers and instructors have difficulty with marketing their teaching materials to their peers. Also, many of the course and teaching materials which are sold, are difficult to customize.

Therefore, there is a need to overcome, or otherwise lessen the effects of, the disadvantages and shortcomings described above.

### SUMMARY

### 1. System—Example A

Presented herein is an interactive teaching and learning system and method. In one aspect, the interactive teaching and learning system is a web-based cloud application in the form of a learning, course design, teaching and communication portal. The system, in an exemplified aspect, utilizes a MVC (Model-View-Controller) framework written in the PHP programming language with a MySQL database. It can support a content management system, user profiles including a super administrator, general administrators, coaches (teachers), and candidates (learners).

The interactive teaching and learning system, in one exemplified aspect, is presented in the form of a hierarchy of websites in which, by way of the content management system, new modules or course segments can be added as blank modules or become translations of the previous course segments as additional websites are added to the platform. In this aspect, each website is identified as a new partner, with its own general administrator, coaches and candidates.

### 2. System—Example B

In one embodiment, the system is operable as method for facilitating education over an electronic network. The method includes the following steps: (a) electronically displaying a course management interface useful to manage an educational course taught by a teacher, wherein the educational course has a sequence of course segments to provide an educational experience for a student; (b) for each one of the course segments, electronically receiving from the teacher, a plurality of course management inputs during the educational course based on the educational experience, wherein each one of the course segments is associated with variable course content; (c) electronically displaying to the student, a course session interface useful to receive the educational experience through the sequence of course segments, wherein the course session interface includes a course navigation menu, and wherein the course navigation menu indicates the sequence of course segments; (d) electronically receiving from the student, a selection of one of the course segments; and (e) electronically outputting to the student, a course output associated with the selected course segment, wherein the course output includes at least part of the variable course content associated with the selected course segment.

In one embodiment, the method includes electronically receiving at least one of a plurality of inputs, including, but not limited, to: (i) a page input for the teacher to add an electronic page or webpage, (ii) a content creation input for the teacher to create at least part of the variable course content within the electronic page, (iii) a document input for the teacher to incorporate an electronic document into the electronic page, wherein the electronic document is part of the variable course content, and (iv) an instruction input for the teacher to add an instruction related to at least part of the variable course content.

In one embodiment, the method includes: (i) enabling the teacher, through the course management interface, to electronically request a student feedback from the student related to the electronic document; (ii) electronically displaying the student feedback to the teacher at the course management interface; (iii) electronically receiving from the student, at least a partially completed version of the electronic document, which is accessible; (iv) electronically providing the teacher with access to the received version of the electronic document through the course management interface; (v) electronically receiving a teacher feedback from the teacher related to the received version of the electronic document; and (f) electronically providing the student with access to the teacher feedback through the course session interface.

In one embodiment, the method includes electronically receiving from the teacher, a downloadable homework assignment document. In one embodiment, the method includes electronically receiving from the student, an upload input to enable the student to upload a completed version of the downloadable assignment document. In one embodiment, the method includes receiving a notice input from the teacher to incorporate a notice into the electronic page with respect to at least part of the variable course content.

### 3. System—Example C

In one embodiment, the system comprises a data storage device configured to store a plurality of instructions. The instructions are executable by a processor to perform a plurality of steps. The steps include the following: (a) receive an educational item building input from a first teaching party, wherein the educational item building input relates to an educational item buildable by the first teaching party; (b) include or incorporate the educational item into a course offerable by the first teaching party in response to a course building input from the first teaching party; (c) receive a marketing input from the first teaching party, wherein the marketing input relates to the educational item; and (d) provide compensation to the first teaching party, wherein the compensation is based, at least in part, on payment received from a second teaching party's purchase of a right related to the educational item.

In one embodiment, the purchased right includes a permission to use a copy of the educational item or permission to modify the copy of the educational item. In another embodiment, at least one of the instructions is executable by the processor to include a copy of the educational item in a second course offerable by the second teaching party in response to a second course building input from the second teaching party. In one embodiment, at least one of the instructions is executable by the processor to modify the copy of the educational item in response to a modification input from the second teaching party. In one embodiment, at least one of the instructions is executable by the processor to: (a) cause a display, wherein the display includes an image associated with the educational item and a price associated with the educational item; and (b) receive the payment from the second teaching party. The display, in one embodiment, includes a portfolio of the first teaching party. In one embodiment, at least one of the instructions is executable by the processor to cause a display of a course management interface and a course session interface.

Other aspects and embodiments of the interactive learning system and method are described herein. This description is meant to fully describe the system and method, but not limit its design, function, or application.

Additional features and advantages of the present invention are described in, and will be apparent from, the following Brief Description of the Figures and Detailed Description.

### BRIEF DESCRIPTION OF THE FIGURES

FIG. 1A is an example of the first part of a data map of an interactive learning system, showing a plurality of software modules;

FIG. 1B is an example of the second part of a data map of an interactive learning system, showing additional software modules;

FIG. 1C is an example of the third part of a data map of an interactive learning system, showing further software modules;

FIG. 2 is one example of a partner site collective/translation map of an interactive learning system;

FIG. 3 is one example of a super administrator permissions flow chart of an interactive learning system;

FIG. 4 is one example of a general administrator permissions flow chart of an interactive learning system;

FIG. 5 is one example of a coach/teacher permissions flow chart of an interactive learning system;

FIG. 6 is one example of a candidate/learner permissions flow chart of an interactive learning system;

FIG. 7 is one example of a graphical user interface showing administrator/coach timeline view & functions of an interactive learning system;

FIG. 8 is one example of a graphical user interface showing candidate timeline view & functions of an interactive learning system; and

FIG. 9 is one example of a graphical user interface showing the reporting function of an interactive learning system.

FIG. 10 is a schematic, block diagram illustrating one embodiment of the system.

FIG. 11 is one example of one embodiment of a course management interface of the system.

FIG. 12 is one example of one embodiment of a course design interface of a course management interface of the system.

FIG. 13 is one example of one embodiment of a language change interface of a course management interface of the system.

FIG. 14 is one example of one embodiment of a course session interface of the system, illustrating the course navigation menu.

FIG. 15 is one example of one embodiment of a course session interface of the system, illustrating content associated with one of the modules or course segments.

FIG. 16 is one example of one embodiment of a course session interface of the system, illustrating a downloadable homework assignment embedded as part of the course content associated with one of the modules or course segments.

FIG. 17 is another example of one embodiment of a course session interface of the system, illustrating a downloadable homework assignment embedded as part of the course content associated with one of the modules or course segments.

FIG. 18 is yet another example of one embodiment of a course session interface of the system, illustrating a downloadable homework assignment embedded as part of the course content associated with one of the modules or course segments.

FIG. 19 is one example of one embodiment of a timeline course session interface of the system, illustrating a checklist of course tasks associated with one of the modules or course segments.

FIG. 20 is one example of one embodiment of a timeline course session interface of the system, illustrating a checklist of course tasks associated with another one of the modules or course segments.

FIG. 21 is a schematic, block diagram illustrating one embodiment of the system coupled to a processor and electronic network access devices over a network.

FIG. 22 is a schematic, block diagram illustrating one embodiment of the system including the teaching subsystem and commerce subsystem.

FIG. 23 is a schematic, block diagram illustrating an example of one embodiment of the educational item library and a course.

FIG. 24 is a schematic, block flow diagram illustrating an example operation of the system.

### DETAILED DESCRIPTION

### 1. System—Example A

The present systems and apparatuses and methods are understood more readily by reference to the following detailed description, examples, drawing, and claims, and their previous and following description. However, before the present devices, systems, and/or methods are disclosed and described, it is to be understood that this invention is not limited to the specific devices, systems, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known embodiment. To this end, those skilled in the relevant art will recognize and appreciate that many changes can be made to the various aspects of the invention described herein, while still obtaining the beneficial method, process and results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used throughout, the singular forms “a,” “an” and “the” include plural referents unless the context clearly dictates otherwise. Thus, for example, reference to “a data set” can include two or more such data sets unless the context indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

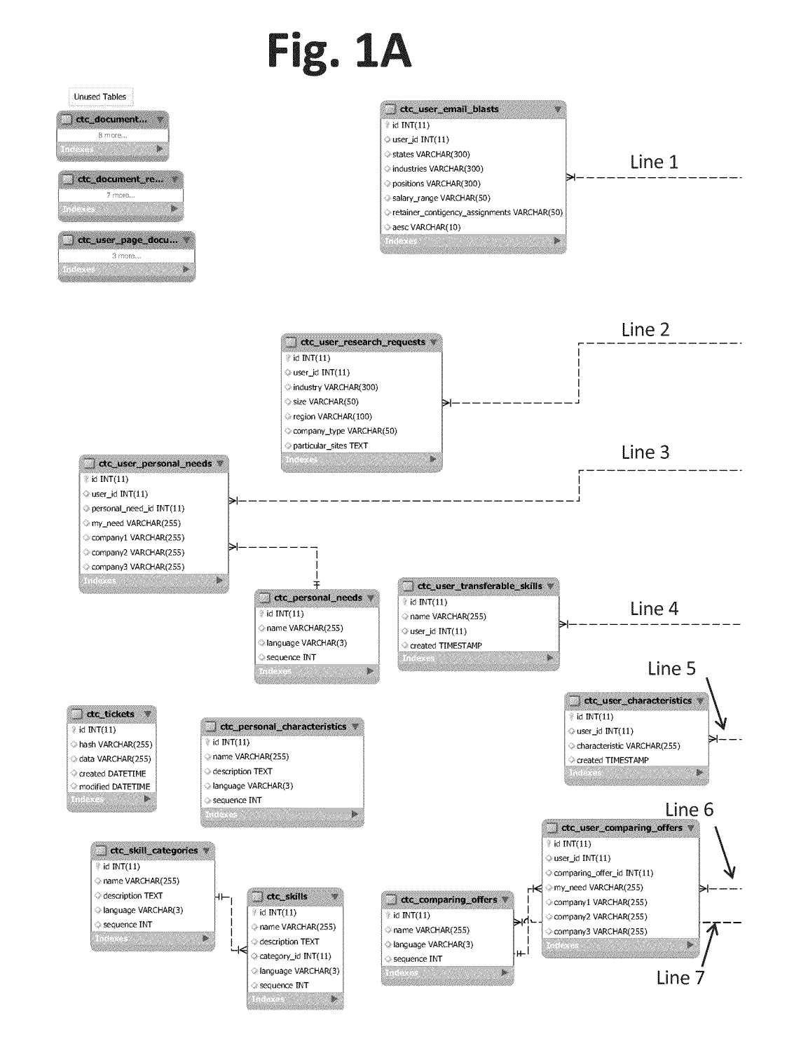

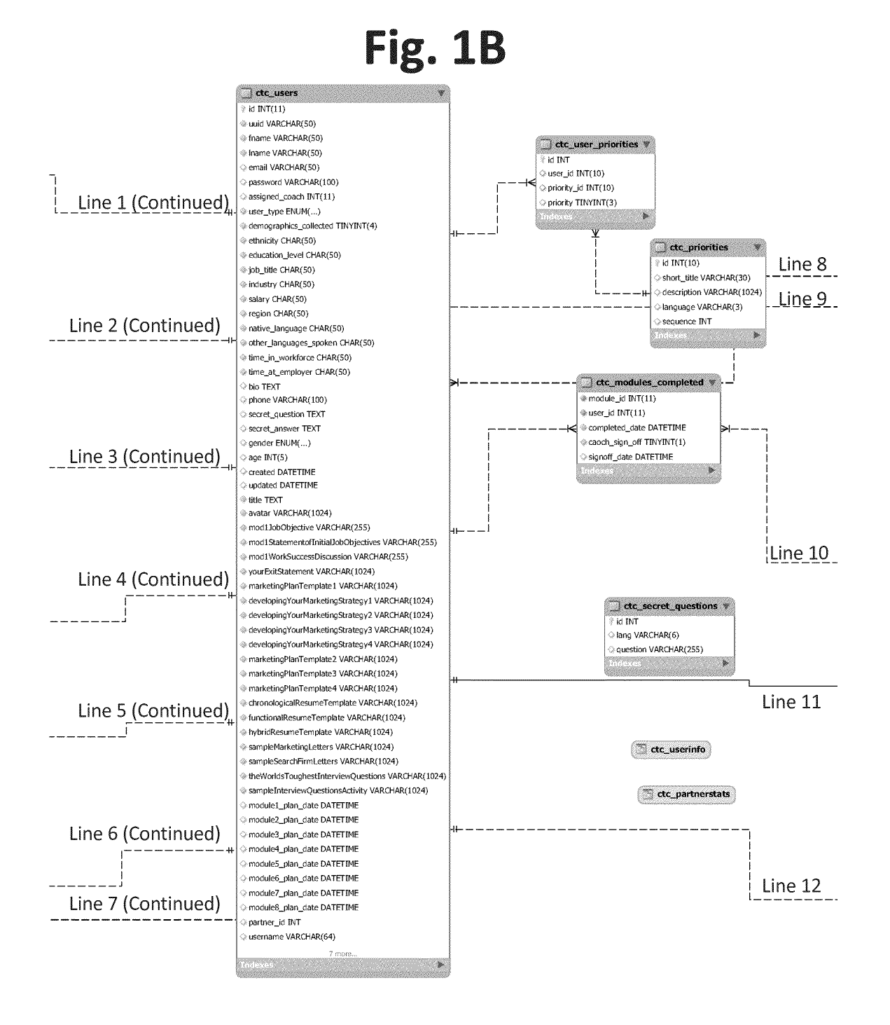

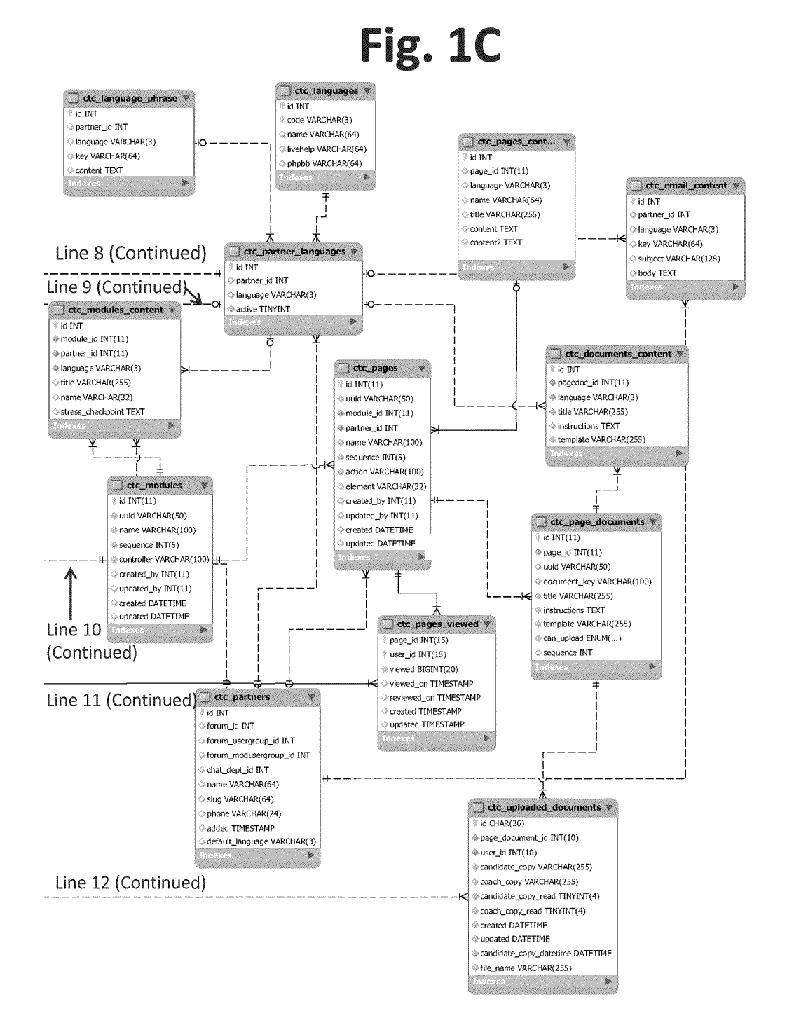

Presented herein is an interactive teaching and learning system and method. In one aspect, the interactive teaching and learning system is a web-based cloud application in the form of a course design, teaching, learning and communication portal. The system, in an exemplified aspect, utilizes a MVC (Model-View-Controller) framework written in the PHP programming language with a MySQL database. It can support a content management system, user profiles including a super administrator, general administrators, coaches (teachers), and candidates (learners). Third-party open source applications can be integrated via customized API to provide communication tools, such as an automatic email system, a forum, and a live chat function. In addition, in another aspect, the system has a built in tracking system that tracks usage details of all parties and other identified variables that the administrator requests in order to generate reports on a variety of identified usage and variables through the built-in reporting function. In yet another aspect, the application can also be configured to build custom modules, course segments or “phrases”, which can become permanent actions that can be added to any module or course segment in the content management system. These phrases can generally consist of custom surveys or forms that can be submitted to an identified user. A data map of the application is shown in FIG. 1.

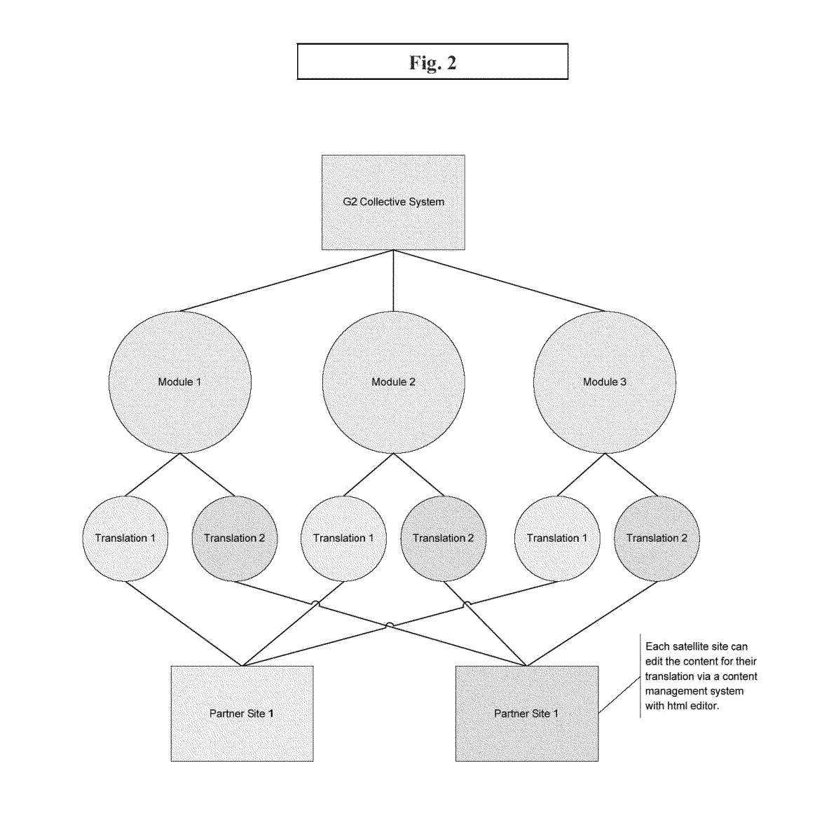

The interactive teaching and learning system, in one exemplified aspect, is presented in the form of a hierarchy of websites in which, by way of the content management system, new modules or course segments can be added as blank course segments or become translations of the previous course segments as additional websites are added to the platform. The terms “module” and “course segment” are used interchangeably to describe one of several components, portions, stages or phases of an educational course. In one aspect, each website is identified as a new partner, with its own general administrator, coaches/teachers/instructors and candidates/students/participants. It is the super administrator function that has access to the “collective” of data and partner websites as it grows as a whole. One of the unique and highly useful features is that there can be an infinite number of partner websites. One aspect of this relationship is illustrated in FIG. 2.

The Content Management System (CMS) can be accessed through the super administrator portal or general administrator portal. In one aspect, the difference between the two is that the super administrator has access to all of the sub-sites in the system. The general administrator only has access to the CMSs to which they have been assigned and are blocked off from the rest of the CMS systems in the “collective” by firewalls. To edit content within a sub-site, the admin is provided a list of the names of the sub-sites they have access to and when the admin clicks on that name they are directed to a content map of the learning material that is broken down into multiple course segments, pages within course segments and documents within pages.

For each module or course segment, page and document, the admin can also select the language for which they are editing. Of course, any variety of languages can be resident in the platform. For example, and not meant to be limiting, English, French, Spanish, Deutsch, and Italian. However, it can be appreciated that the platform is structured so that new languages can be added at any time. Some or all of the languages can also be supported by the Chat software and the Forum software.

In other aspects of the system, the CMS can include the ability to edit the languages available for the user to choose when they login or within their profile, the ability to edit automated notification emails and the ability to edit phrases, which are customized pages that have special features which are not part of the regular page features within a module or course segment (e.g. custom built survey pages, text on the sub-site home page, a copyright notice (or any notice) viewed on the login page).

Within the CMS, the learning content can be visually presented in a list that mirrors the process in which the learners view the content and complete activities. Current modules or course segments are numbered, for example 1-8. They are easiest compared to chapters of a book. To name a module or course segment, a user can click on the language that they would like to edit underneath the course segment number and have the option to enter a Name for that course segment in a field. The name that is entered here is the name that the learner sees on the course segment icon on their homepage.

Pages can be listed under each course segment and identified by the title that the admin gives to the page. The admin can add a plurality of pages, per their choice. In one aspect, this is done by clicking on the add page button for the specified course segment. When the button is clicked, a field pops up in which the required information to create a page can be entered. Exemplified information entered can be a page title and an Element. The page title is the title that the learner sees as a tab when they are inside the course segment. The Element refers to the features of the page. In the alternative, selecting the element, “None,” creates a page that doesn't have any special features. Pages with elements are pages that require “phrases” as mentioned previously. This is the way to insert a custom built survey within any course segment, a way to substantially automatically insert a page that is connected with a user and shares data about them (for example, automatically insert the biography of the teacher that is assigned to a learner), a custom built form that asks the learner to select criteria and submit their selections for review, or a page that shows the content/course timeline and its interactive features. This timeline is substantially the same as the list that the admin sees in the CMS, separated, by Course segments and pages, but can exclude certain details such as documents and language options.

There can also be a button to edit the page settings (title and element) at any time after creating a page, as well as a button to delete the page.

In another aspect, to add content or edit the content of a page after the page is inserted, clicking on the name of the language a user wants to edit the page in (languages are listed under the page title) will bring the admin to a new page which contains a field for the page name, a field for the page title, WYSIWYG (what you see is what you get) content editors for regular page content and footer content, buttons for saving, previewing or canceling work, and a content preview section.

The Page Name entered can be reflected on buttons and navigation pertaining to that page that the learner sees within that course segment. The page title, in one aspect, shows up above the content on the page when the learner is viewing that page in the learning portal. The WYSIWYG editor can contain features available for basic word processing, HTML source editing, and adding and/or editing images and multimedia files. There can be a plurality of WYSIWG editors available for each page to increase formatting flexibility on pages. In one aspect, if a Document is inserted on a page and the admin wants to continue with text content on that same page underneath the document window, the footer WYSWYG editor becomes available because of the break in the content that the WYSIWYG editor supports. (Documents are, in this aspect, inserted outside of the WYSIWYG editor as a substantially different function for interactive communication purposes). Clicking on the Preview button after adding content into the editors allows the admin to see what the content will look like in the dedicated preview section at the bottom of this page. Clicking on the Save button deploys the content immediately and makes it go live and visible to the learners with access to the specified sub-site. Clicking on the Cancel button deletes any changes made since the last Save and directs the admin back to the Course segment content list. As can be appreciated, each Language available can have its own editing space for each Page.

In another aspect, the CMS also allows the admin to insert fields on pages that allow the teachers and learners to upload and download documents as a means of completing activities and coursework when there is a need to use the content outside of the system, and when there is a need for feedback to be exchanged between the teacher and the learner around the activity. Scenarios for adding a document field to a page can include, for example and not meant to be limiting, 1) to make content available that a learner can upload to their computer and manipulate, modify, print or do anything they would need to with that document outside of the platform; 2) to make a designated “space” available for a learner to submit work product to a teacher; 3) to make a space available for the learner and the teacher to go back and forth uploading and downloading work product and feedback (continuous editing process); 4) to make a designated space available for a teacher to share a document with their student, such as a progress report, assessment/survey results, and the like.

In this aspect, documents can be added to a page by clicking on the “Add a document” icon for that given page. Then, a field pops up which requires the admin to name the document and select the uploading permissions for the document. Uploading permissions determine who can upload a document to the document field. In another aspect, permission choices include: Learner only, Teacher only, both Learner and Teacher, and nobody. These permission options enable required functions to fulfill the listed scenarios for adding a document field to a page. Once the document field is added, it is listed by title on the course segment content list in the CMS. It is listed at an indent underneath the page where it exists. Underneath the document title, the admin has the choice to edit the document in all languages, just like editing pages. To edit the document, the admin clicks on the desired language and is taken to a page with a field that lets the admin upload a document template (can be any file type). There is also a field that allows the admin to enter instructions for what the learner is supposed to do with the document. There is a Save button on this page which deploys the document immediately and makes it go live and accessible to the users who have been granted access to the sub-site. There is also a Cancel button which deletes any changes that have been made since the last Save and directs the admin back to the Course segment content list in the CMS.

Each time a learner uploads a document to a document field, their assigned teacher can be sent an automated email to notify them that a new document is available for them to upload and review. The teacher can upload this document from their own Teacher portal (explained later). Accordingly, each time a teacher uploads a document for a learner to review, the learner is sent an automated email to notify them that the document is available and where to find it within the course segments and pages. These automated emails are examples of content that is edited in the Phrases section of the CMS.

In one aspect, there are a plurality of user levels within the system. For example, Super Administrator, General Administrator, Coach/Teacher/Instructor, and Candidate/Learner/Student. Each user level can have different permissions as to which pages they are able to view, and are able to take certain Steps to complete certain Actions.

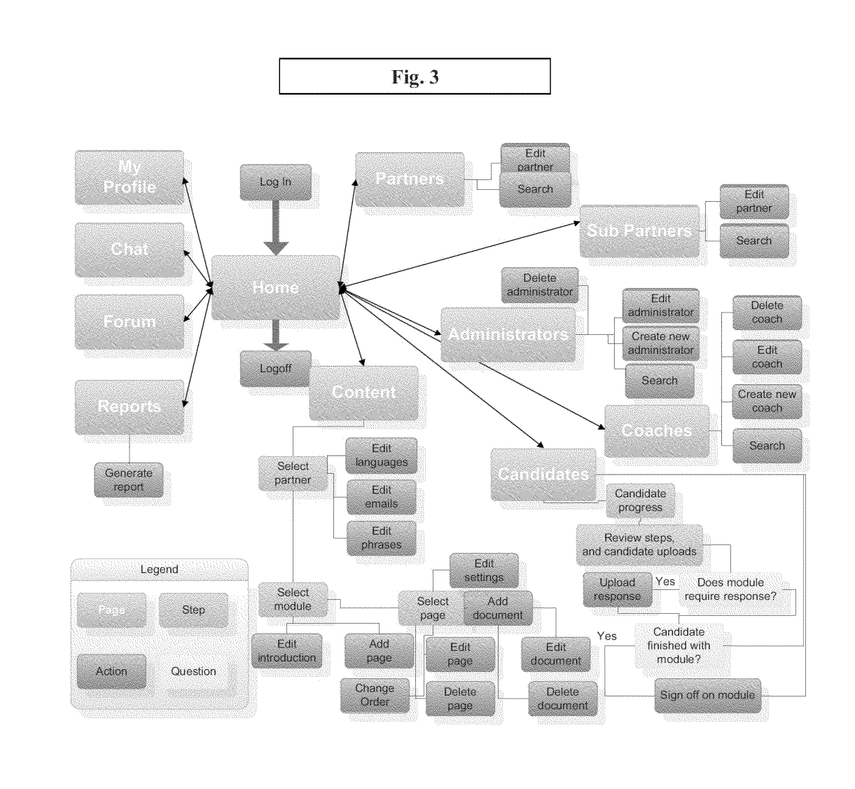

In an exemplified aspect, the Super Administrator is the only user that has access to everything within the application framework, content and data within all Partner sites (sub-sites). The Super Admin can edit information within its own profile. Profile information is used to identify users when they are linked together in various teaching/learning/administrative relationships and when they are communicating throughout different parts of the collective, such as the forum or chat discussions. The Super Admin has full access to all Partner sites and is able to edit their Administrators, Coaches and Candidates, and Content. The Super Admin is also able to view and monitor all chat, forum and email conversations within the collective. They also have the ability to run reports on any data within the collective (e.g. a report on global users, users within a given Partner site, or even zero in on one coach's or candidate's data, or a group of coach and/or candidate data). This is shown in FIG. 3.

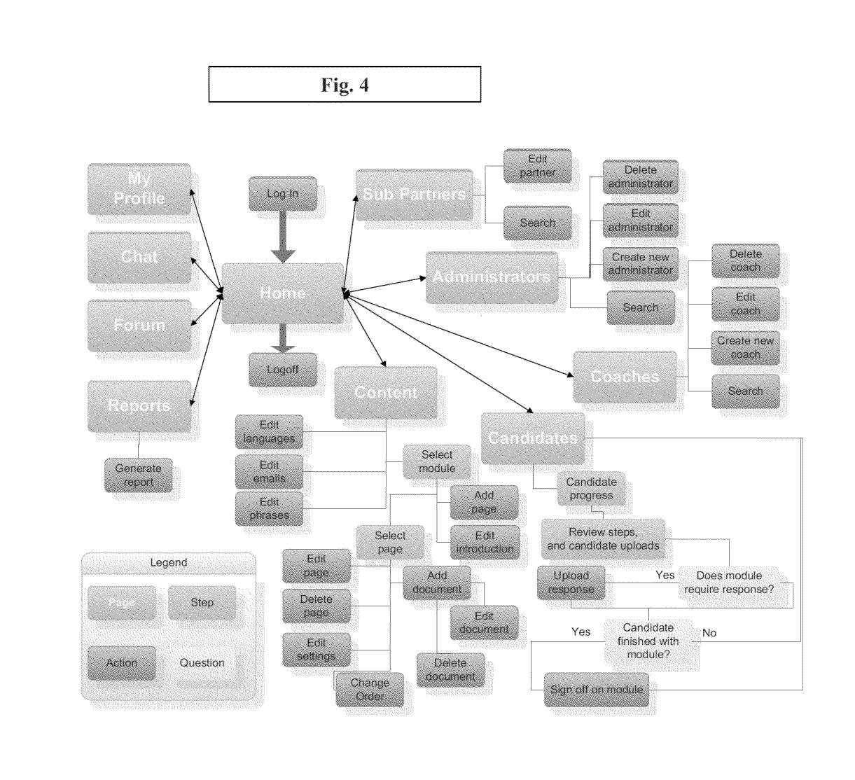

In some aspects, the General Administrator can to perform the same functions as the Super Administrator, but only within the sub-sites for which they have administrative permission. This means that they only have access to Teacher and Learner information, content and communications within the permitted sub-site(s), and can only run reports on information generated within those sub-site(s). This is exemplified in FIG. 4.

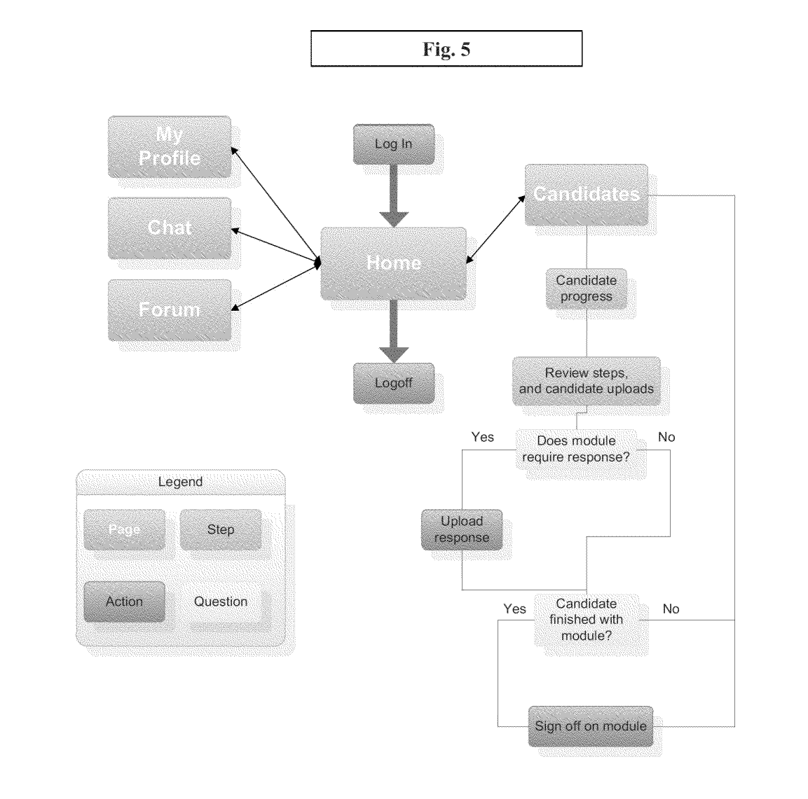

In another aspect, coaches/Teachers can access information on Candidates/Learners to which they have been assigned. A Teacher is created by either a Super Administrator or a General Administrator and assigned to a sub-site for which they will be teaching the content. Coaches/Teachers are able to make changes to their own profile, chat with their Candidates/Learners, participate in forum discussions, create new Candidates/Learners, view their Candidates/Learners progress, upload documents for their candidates/learners and sign off on their Candidates'/Learners' work. This relationship is shown in FIG. 5.

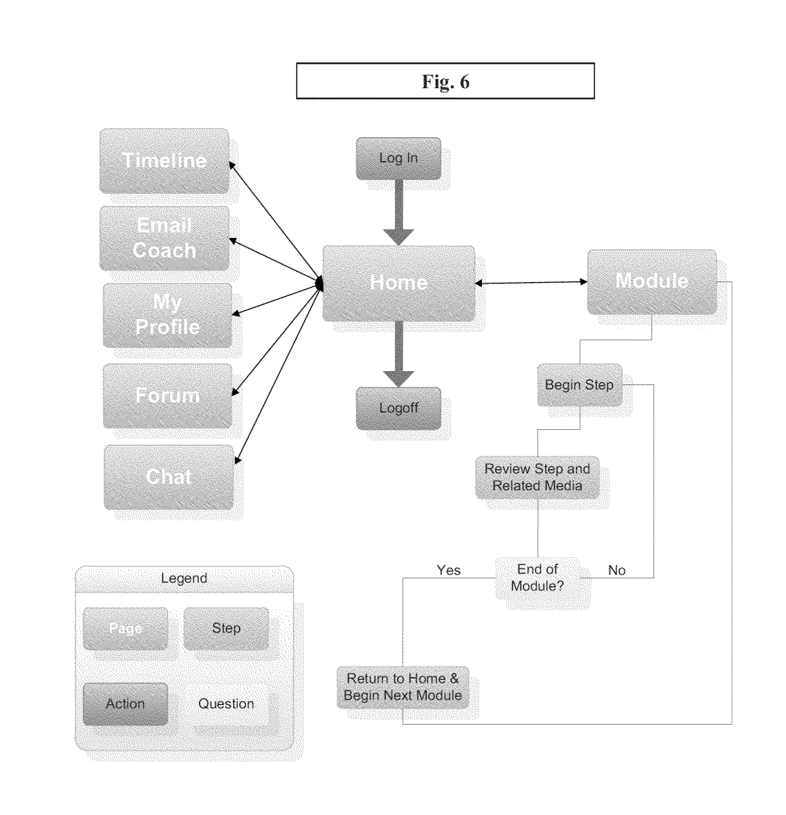

In yet another aspect, Candidates/Learners can access their own portal, which consists of the content in the course segments which has been inserted by the administrator for the sub-site they have been assigned to, their own work product within these course segments, their own interactive program timeline and their profile. They also have the ability to email their Coach/Teacher directly through the portal, request a chat session with a Coach who is online, and participate in forum discussions. This relationship is exemplified in FIG. 6.

In an exemplified aspect, upon logging in, the candidate/learner sees a guided learning process throughout the course segments, pages and documents that were created in the content management system. When a new candidate/learner profile is created, the user who creates the initial profile sets a permission for either sequential or random viewing of course segments and pages depending on how they prefer to present the content to the learner. Sequential viewing is helpful when the teacher wants to deliver information in a controlled, specific order. In this case, the candidate must view each course segment and page within the course segments, and unlock each page by clicking a button that takes them to the next page. Sequential viewing is also helpful when a teacher wants to ensure that a learner completes certain work product in a specific order. For example, there can be built in “phrases” (such as a survey or test) that must be completed before moving forward. Random viewing unlocks all of the pages and is helpful in situations where the information flow process is open and the learner might need access to all information within the course segments simultaneously to achieve learning program goals. The ability to set viewing order as Sequential or Random is a tool that the Teacher can use to guide Students as individuals and/or groups through the interactive learning process for each course.

The interactive timeline serves many purposes for all users. For Administrators, the timeline is a map of the course material and the order and format in which it will be delivered to the learner, a quality control tool, and the basis for running usage reports. For the Coach/Teacher, the timeline is the interactive work space in which they keep track of their Candidates'/Learners' progress, download material uploaded by the candidate, upload material and feedback to the candidate, keep track of completion dates/times and feedback dates/times, and sign off on work the Candidate/Learner completes. For the Candidate/Learner, it also serves as a way to keep track of what has been completed, signed off, and an overview of the content in the course segments, like a course syllabus. It also has a goal setting tool which allows candidates to pick out dates which they would like to have completed course segments, which reflect on the Coaches view of the timeline as well.

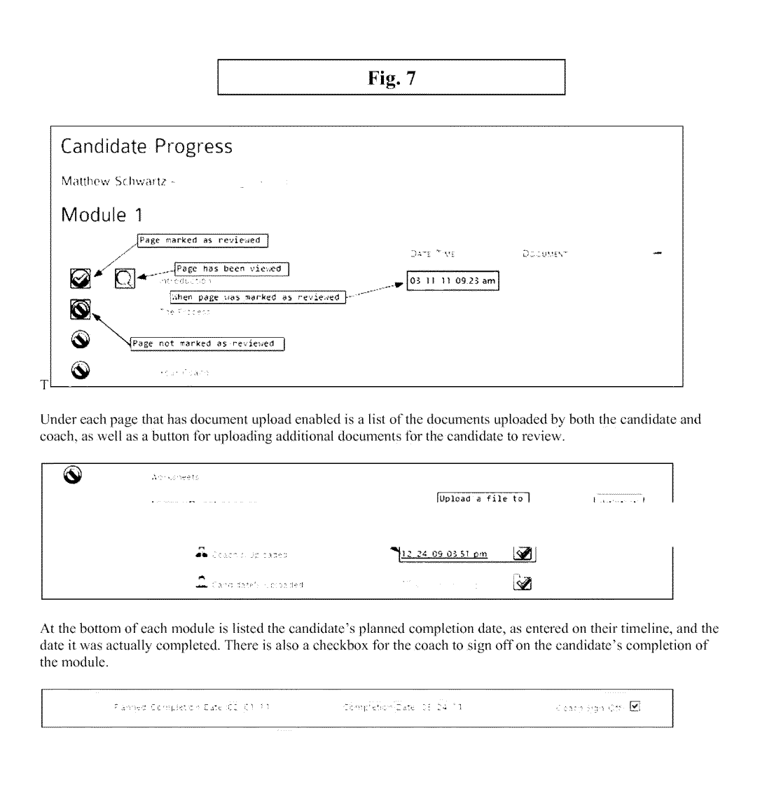

On the Administrator and the Coach/teacher view of the timeline, there are symbols next to the title of each page that indicate if a page has been viewed by the candidate, marked as completed by the candidate, or not viewed at all. When a candidate uploads a document, a folder icon appears on the timeline next to the document title, so that the coach can login and click on the folder to download the document. The coach can then click on an upload button next to the folder icon, and upload a document with comments and feedback on the work product. Refer to FIG. 7, which illustrates the Administrator/Coach Timeline View & Functions. Time restrictions can be set to remind the coach/teacher to respond to a candidate's upload within a certain time period. For example, if a user wants the coach to respond to the candidate within 24 hours of receiving a document, the restriction can be set to 24 hours, and if the coach doesn't upload anything within that time period a red message that says “Coach's response needed” appears on the timeline under the candidate's document. There is substantially no limit to how many documents can be uploaded back and forth between candidate and coach, and all iterations of the document are stored in the coaches and admin timelines and database. Administrators view the timeline in the exact same format as the coach.

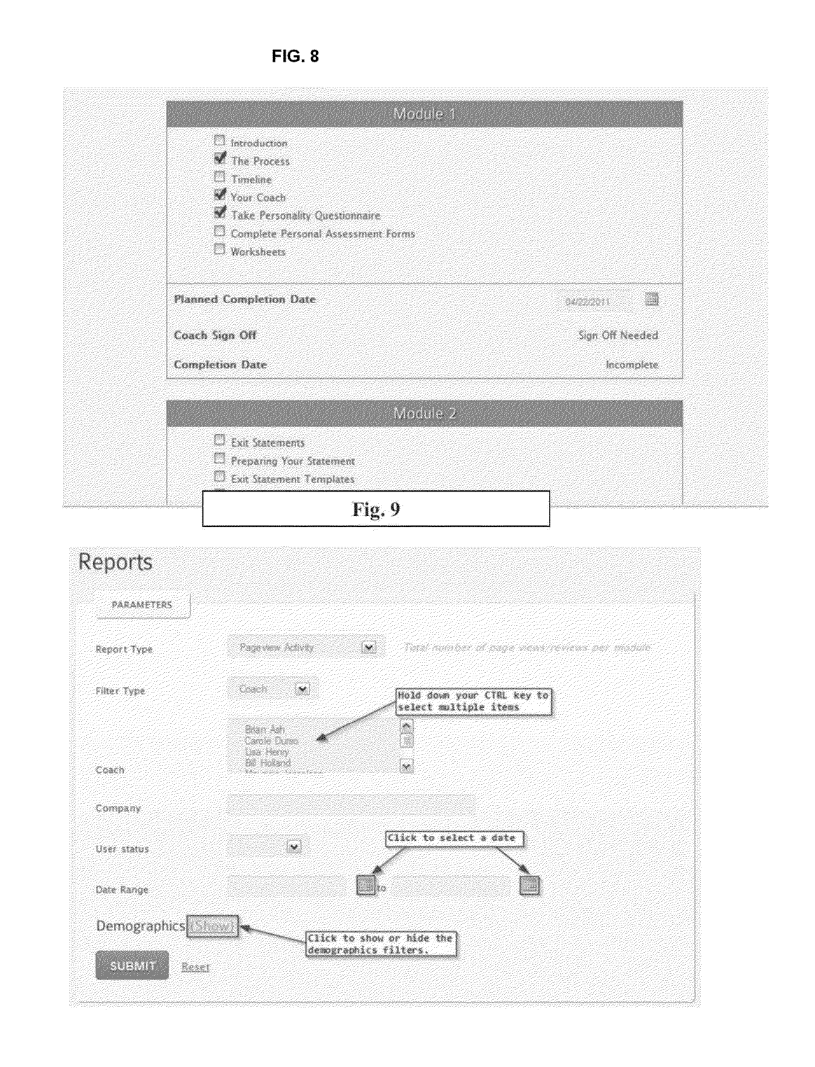

In another aspect, Candidate's however, do not access the documents on their timeline, and only have direct access to their own latest upload and their coach's latest upload. They access these documents in the upload/download windows on the pages within course segments that instruct them to complete the work product. What candidates do see is checkmarks on the timeline next to the pages that they have marked as reviewed, what their planned course segment completion dates are, and whether or not their coach has signed off on course segments. FIG. 8 illustrates Candidate Timeline View & Functions.

The system Super Administrator and General Administrator user portals can have built in reporting functions. The Super Administrator can run reports on all data existing within the entire collective of sub-sites. General Administrators, in one aspect, can only report on data within the sub-sites they are assigned to. Reporting parameters can be set around Report Type (Page view activity, Course segment page view activity, user history, and/or an overall usage summary), Partner/Sub-site, Filter Type (Coach, Candidate), Individual Coaches, Company, User Status (Active, Inactive), and Date Range. In addition to these basic filters, other filters, such as demographic filters using variables/information that the candidates have provided for their profile (education level, ethnicity, languages spoken, salary level, job title, geographic region, industry, etc.) can be utilized. These parameters and variables allow Administrators to run reports on application usage data and on any number or group of candidates and coaches. For example, if a user wanted to know how many page views occurred between a date range within a predetermined Course segment by the candidates of a first company being coached by a first coach, this selection can be submitted, run through the database and generate a bar graph with the data, as well as the option to see raw data. Depending on the program goals for the teachers, learners and companies, reporting variables can be changed/added to include any information that will be helpful for the given sub-site's administrators and users. Reported data is generally helpful for decision making, quality control, growth tracking and marketing data generation. FIG. 9 shows one aspect of a Reporting Function.

In one aspect, methods of communication within system are focused around well established, proven learning protocols: content delivery, inquiry, discussion, and giving and receiving feedback. To facilitate, third-party open source applications can be integrated via customized API to provide communication tools such as an automatic email system, a forum, and a live chat function.

At any time, the application structure can support the integration of new third party apps. In one aspect, the uploading/downloading fields are checkpoints that prompt the production of work product wherever they are placed in the program, and encourage and direct the giving and receiving feedback process at specified times depending on where they are placed within the course segments and the pages.

Accordingly, the course designer can use the placement of these windows to control and determine the “labor intensity” or estimated work hours that the teachers and learners will be spending in the feedback process, which like editing and grading papers is often the most time consuming part of the work that is done by the teacher.

As can be appreciated by those skilled in the art, by using a cloud environment to facilitate the teaching and learning experience, thereby foregoing the need to download special software, there is a low cost point of entry for recipients of training and an increase in efficiency and flexibility of teaching opportunities.

Since, in many aspects, the application is cloud based, it can facilitate a growing collection of knowledge/data at increasingly rapid rate as sub-sites, course segment translations and general content are created and connected. As such, integrating open-ended data search tools and other knowledge mining tools into the collective database is contemplated.

As mentioned herein above, there is a plurality of course segments available for all users. The Super Administrator or General Administrator, in one aspect, can add and subtract course segments from the CMS of each sub-site at any given time. In one aspect, these are sub-course segments, and they can take away the restrictions around the number and types of course segment translations within the collective.

In one exemplified aspect, learning and feedback relationships exist between learners/candidates and teachers/coaches. In order to facilitate group learning, feedback and project work, the system can also allow administrators to assign groups of learners and teachers (unlimited numbers) to each other, and a shared workspace that the group has access to which appears within their personal portals. This permits them to share information and upload/download and give feedback on group documents, as well as chat with each other and make updates in real time. In another aspect, the group workspace can integrate live webinar and screen sharing technologies to facilitate real-time collaboration. Much of the communication and webinar tools can be added via third party API.

Naturally, part of the learning process is evaluation. In one aspect, the CMS allows custom phrases to be added to course segments which can be surveys and/or assessments. In this aspect, they are built separately and then inserted into the system. In another aspect, there is a custom survey/assessment builder added directly into the CMS so that assessment can be more easily, openly integrated into any course segment and graded automatically. The builder can include all standard question building tools such as multiple choice, short answer, true/false, matching and open-ended essay. It can also include both formative and summative assessment structures.

In one aspect, the administrators can make certain pages, course segments and assessments available to users or restricted to users within certain time periods. This is useful when teachers want to deliver information on a daily, weekly or monthly basis without the ability to skip ahead, or when there is a crucial timed test on material. It can also help discourage cheating behavior in certain testing environments.

The system can also comprise a live video chat feature, a group project management calendar, and a live video streaming capability to facilitate live event participation.

### 2. System—Example B

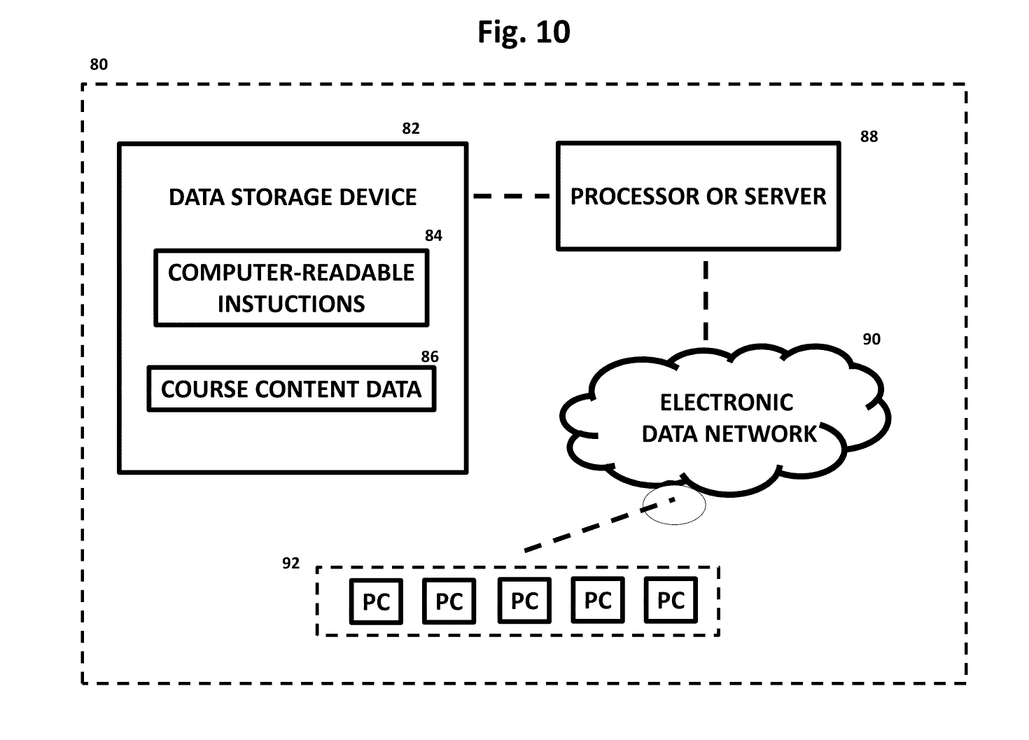

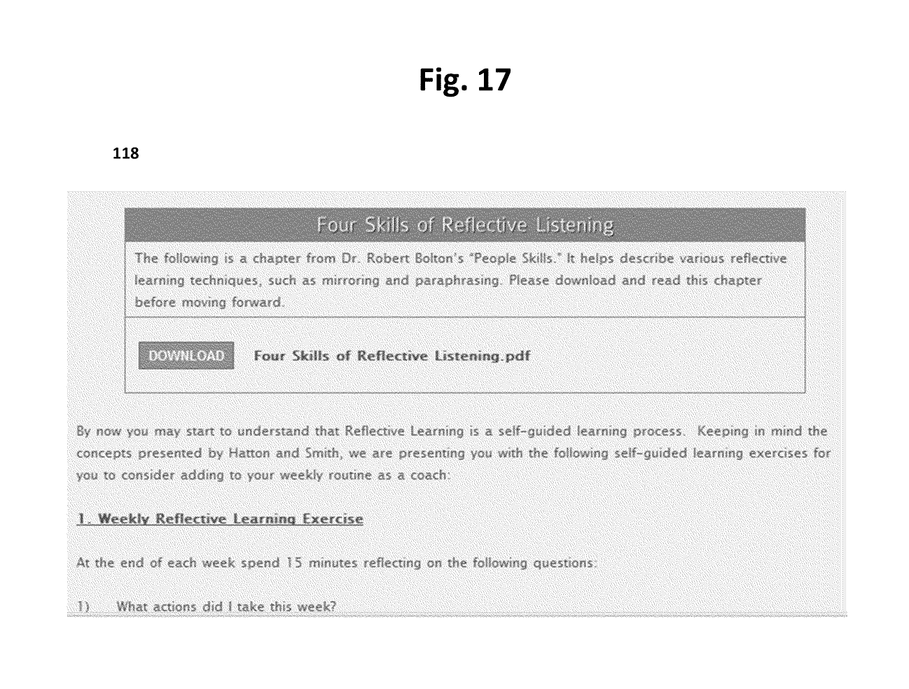

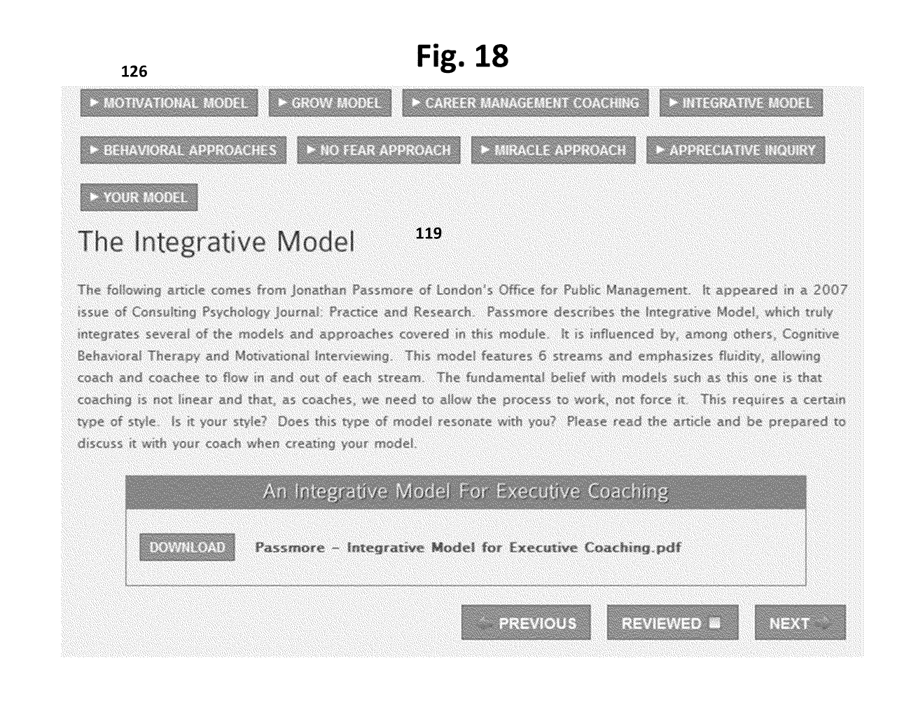

Referring to FIGS. 10-20, in one embodiment, the system 80 includes a data storage device 82, such as a database or memory device. The data storage device 80 stores one or more software programs, software modules of computer code or computer-readable instructions 84. Also, the data storage device 82 stores variable course content data 86. The data storage device 82 is coupled to a processor or server 88 operating on an electronic data network 90, such as the Internet. In one embodiment, the data storage device 82 is accessible to a plurality of personal computers 92, mobile phones or other network access devices which are connected to the network 90. The processor 88 executes the computer-readable instructions within the data storage device 82 to receive designated inputs from the end users, including, but not limited to, teachers and students, who operate the computers 92. In response, the processor causes the system 80 to generate outputs, such as graphical interfaces or interfaces, graphical representations, transactions, sounds or audiovisual outputs.

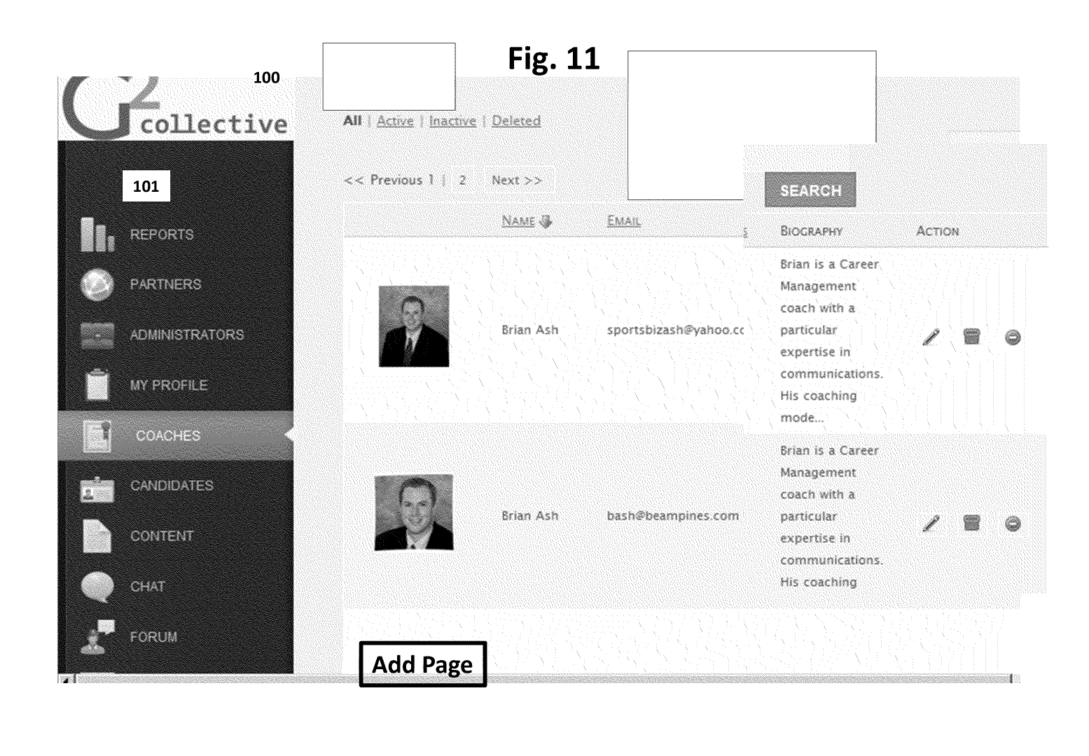

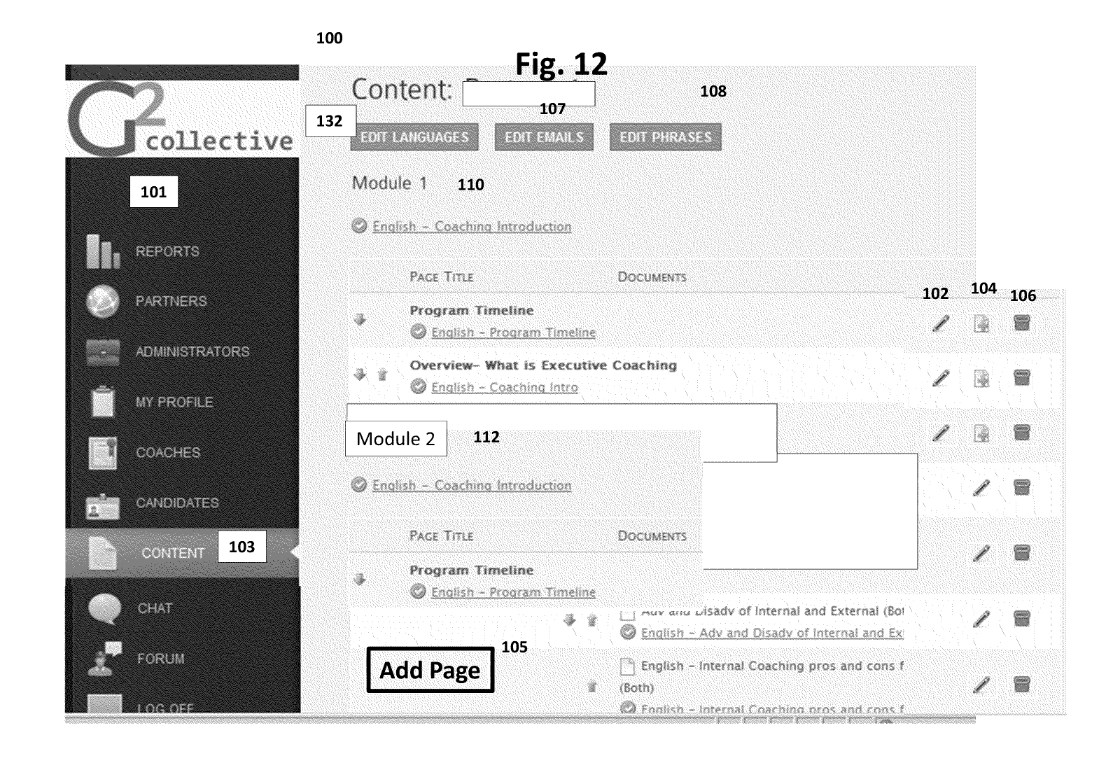

In one example illustrated in FIG. 11, the system 80 displays a course management interface 100 to teachers or administrators who are registered users. The course management interface 100 includes a course management menu 101. The course management menu 101 indicates a plurality of software modules, including, without limitation, a reports software module, a partners software module, an administrator software module, an administrator profile software module, a coaches or teachers software module, a candidates software module, a content management software module, a chat communication software module and a forum software module. The system receives inputs associated with a user's selection of these software modules, and the system manages or runs the functionality associated with the selected software modules.

In one embodiment, the software modules of course management menu 101 are incorporated into the system in a modular fashion. In one embodiment, one or more of these software modules can be added to the system or removed from the system without impairing the other aspects of the system.

In one example illustrated in FIG. 12, when the teacher selects the content software module 103, the system displays a course management interface 108. The course management interface 108 enables the teacher to design, modify and manage variable course content for the educational experience of one or more students throughout the course session. The educational course can have a sequence of course segments, which, in one embodiment, are organized in a step-by-step fashion to be completed in chronological order.

In the example shown in FIG. 12, course segments 110 and 112 are identified as “Module 1” and “Module 2,” respectively. For each one of the course segments, the system is operable to receive a plurality of different types of course management inputs 105, 102, 104, and 106 associated with variable course content provided by the teacher or administrator.

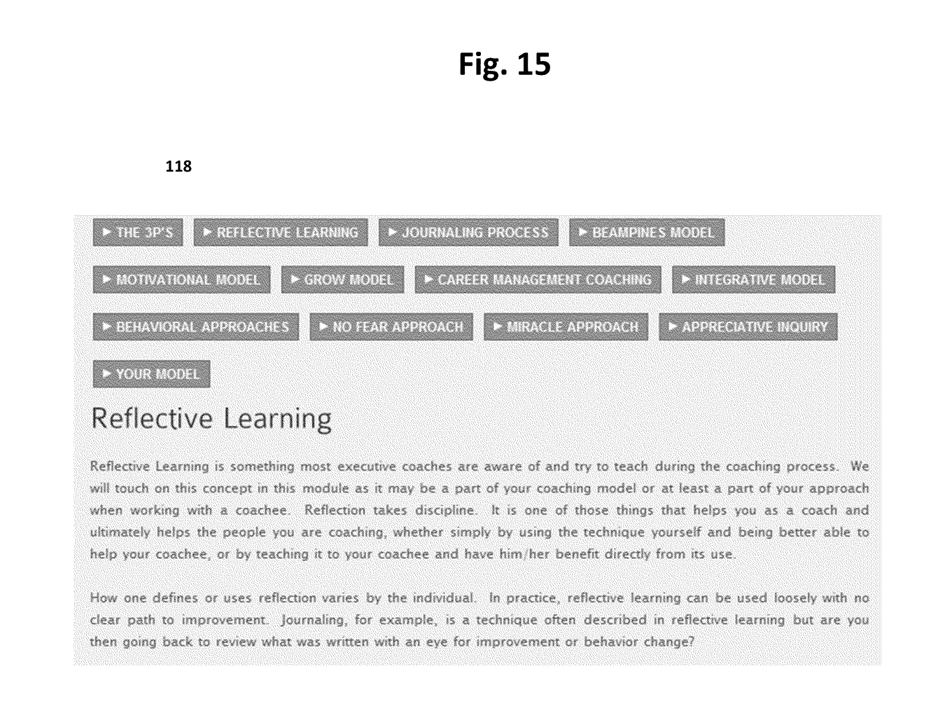

In one example, the course management input 105 is an electronic page addition input, enabling the teacher to add and create an electronic page or webpage, such as webpage 118 shown in FIG. 15. The system, in one embodiment, the course management interface 108 includes an editor which enables the teacher to create text and content, including, without limitation, audiovisual content, while within the webpage 118. The system makes the webpage 118 accessible to the student through the course session interface 114 described below.

Referring back to FIG. 12, in one example, the course management input 102 is a profile editor input, enabling the teacher to create or edit the title and other attributes of the webpage 118. The course management input 104 is an electronic document addition input. The teacher can use the electronic document addition input to incorporate desired course content, such as downloadable assignments, into a desired course segment. The course management input 106, in one example, is a delete input, enabling the teacher to remove an electronic document from the system.

In one embodiment, the course management inputs include an instruction input enabling the teacher to add an instruction for the student related to at least part of the variable course content. For example, the teacher may add an assignment document to be completed by the student, accompanied by the instruction, “Read speech aloud before returning outline.” The system displays such instruction to the student through the course session interface 114 described below.

The course management interface 102 enables the teacher to vary the course content throughout the course session depending upon student performance and the progress or status of the educational experience. The course content, when updated by the teacher, is displayed, or made accessible, to the students through the course session interface 114. After the students access the updated content, the students may submit completed assignments for grading or review by the teacher. The system facilitates the interchange by including customizable teacher instructions, teacher feedback, and student feedback.

In one embodiment, the system includes an email alert software module 107 as illustrated in FIG. 12. This module 107 generates alerts to students in the form of emails. The emails are customizable and selectable from a set of form emails. When the teacher adds a document or homework assignment through the course management interface 108, the system automatically sends the associated email alert to the students. For example, an email alert may state, “A new homework exercise has been assigned. Click on the following link to download the exercise.”

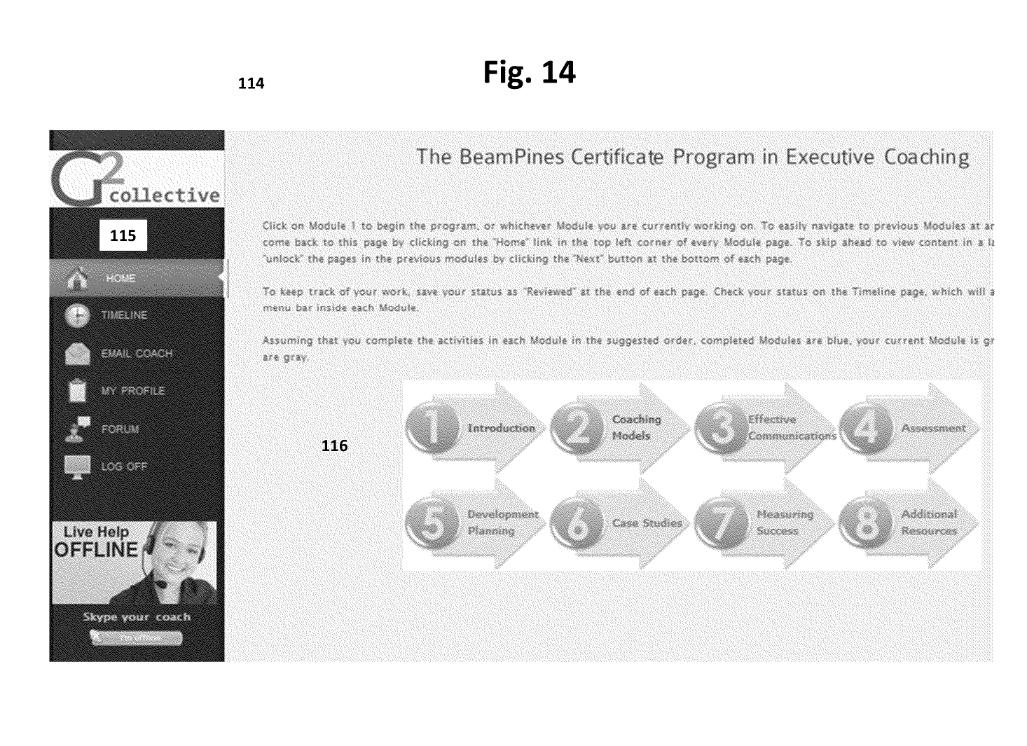

To the students or enrollees, the system displays a course session interface 114, as illustrated in FIG. 14. In one embodiment, the course session interface 114 includes a main course session menu 115. The main course session menu 115 identifies a plurality of functional features or software modules, including a home page, a timeline page, an email software module, an account profile software module, a forum software module, a log off software module, and a chat software module. The system receives inputs associated with the user's selection of these software modules, and the system manages or controls the functionality associated with the selected software modules.

In one embodiment, the software modules identified by the main course session menu 115 are incorporated into the system in a modular fashion. In one embodiment, one or more of these software modules can be added to the system or removed from the system without impairing the functionality of the other aspects of the system.

The course session interface 114 enables the students to receive an education through the sequence of course segments. In one embodiment, the course session interface 114 includes a course navigation menu 116 as illustrated in FIG. 14. The course navigation menu 116 indicates the sequence in which the course segments should be, or must be, conducted. In the example illustrated in FIG. 14, the course navigation menu 116 indicates the eight course segments within arrows, labeled numerically, “1” through “8.” In one embodiment, the system enables the teacher or administrator to require the student to successfully complete one of the course segments before proceeding to a subsequent course segment.

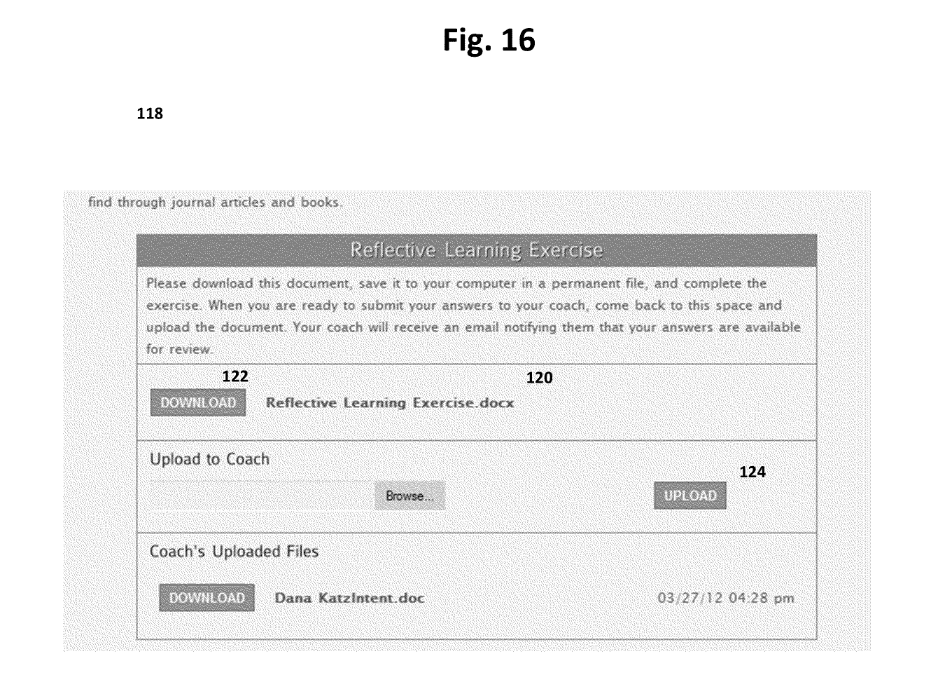

Referring to FIG. 15, when the student selects one of the course segments, the system produces course output 118 in the form of the webpage created by the teacher. The output, electronic page or webpage 118 is associated with the selected course segment, as illustrated in FIG. 15. In the example provided in FIGS. 15-16, the course output includes a Reflective Learning Exercise. The student must download the reflective learning exercise document 120 using the download input 122, complete the exercise, and upload the completed document using the upload input 124.

In one embodiment, the course output includes a downloadable homework assignment document accessible at the course session interface 114. In another embodiment, the course output includes a video which is viewable at the course session interface 114.

In another example illustrated in FIG. 18, the course session interface 114 includes a segment topic menu 126, which includes hyperlinks to the different topics of the applicable course segment.

In one embodiment, the system includes a plurality of computer-readable instructions executable by the processor to: (a) enable the teacher to use the course management interface to request a student feedback from the student related to an assignment (in the form of an electronic document or other form) assigned by the teacher, wherein the course session interface displays the request, for example, “Complete this assignment by tomorrow, and double check your quadratic equation calculation;” (b) enable the student to provide the student feedback using the course session interface, wherein the student feedback is displayed to the teacher at the course management interface, for example, “I did my best but had difficulty with the quadratic equation;” (c) receive from the student, at least a partially completed version of the assignment; (d) enable the teacher to access the received version of the assignment; (e) receive a teacher feedback from the teacher related to the received version of the electronic document, for example, “Check your negative signs in the equation;” (f) enable the student to access the teacher feedback; and (g) repeat steps (b) through (e). This loop or cycle of teacher-student interchange facilitates the learning process with ease of use.

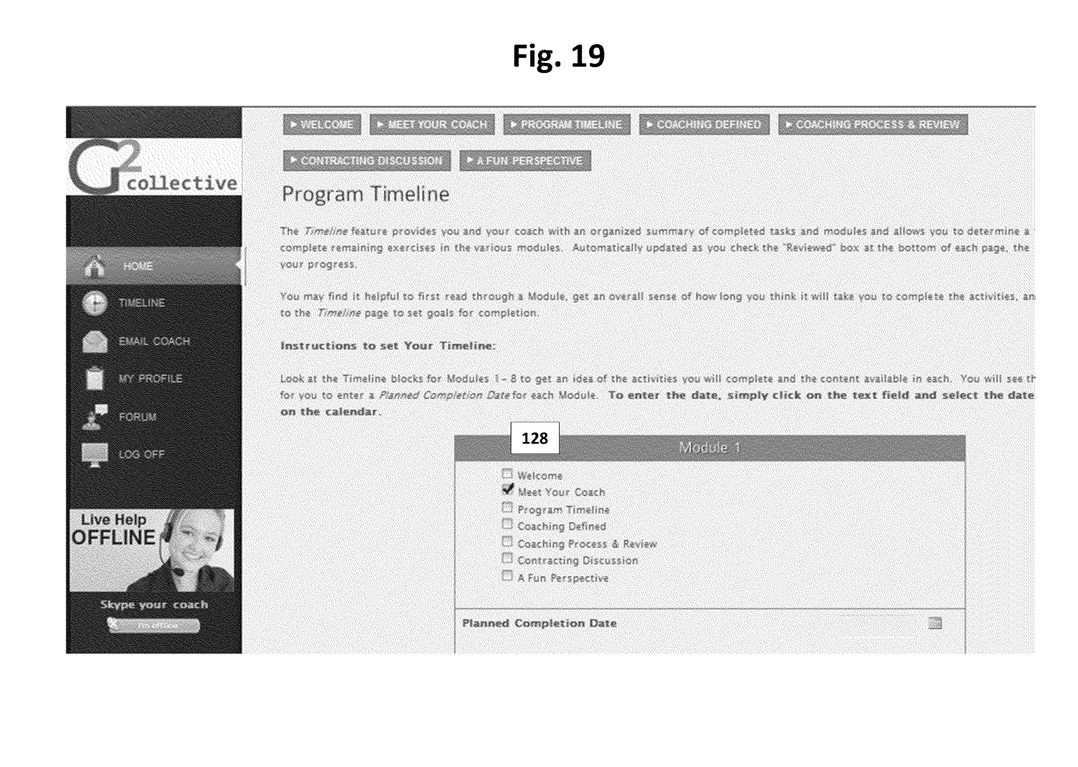

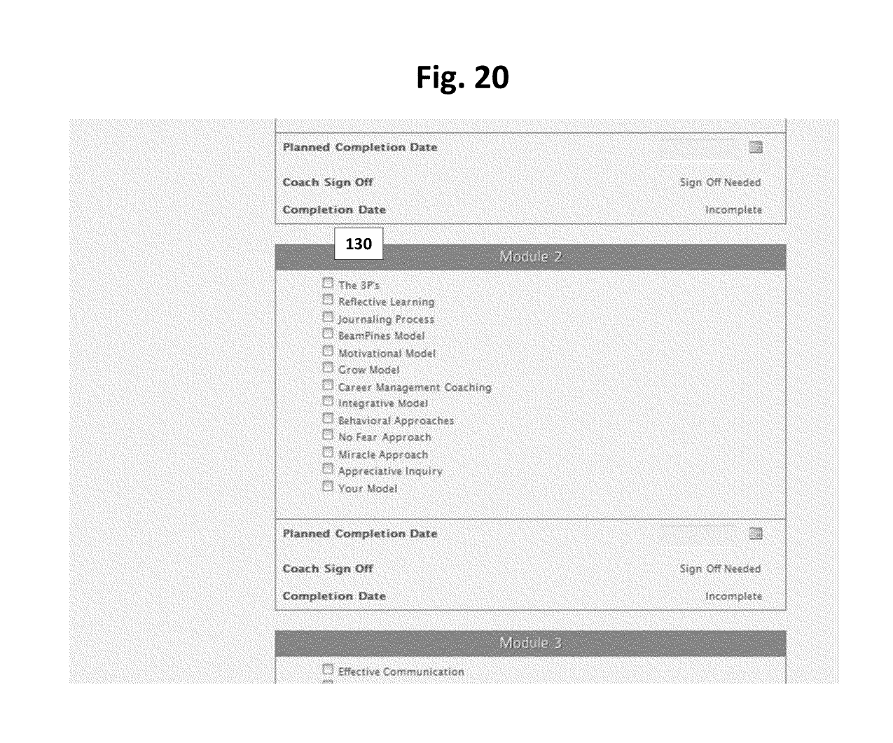

In another example illustrated in FIGS. 19-20, the course session interface 114 includes a plurality of timelines or time-tracked checklists 128 and 130 associated with the course segments 110 and 112, respectively. Each such checklist identifies the requirements or tasks of the corresponding course segment. The checklist also indicates whether the requirements or tasks have been completed.

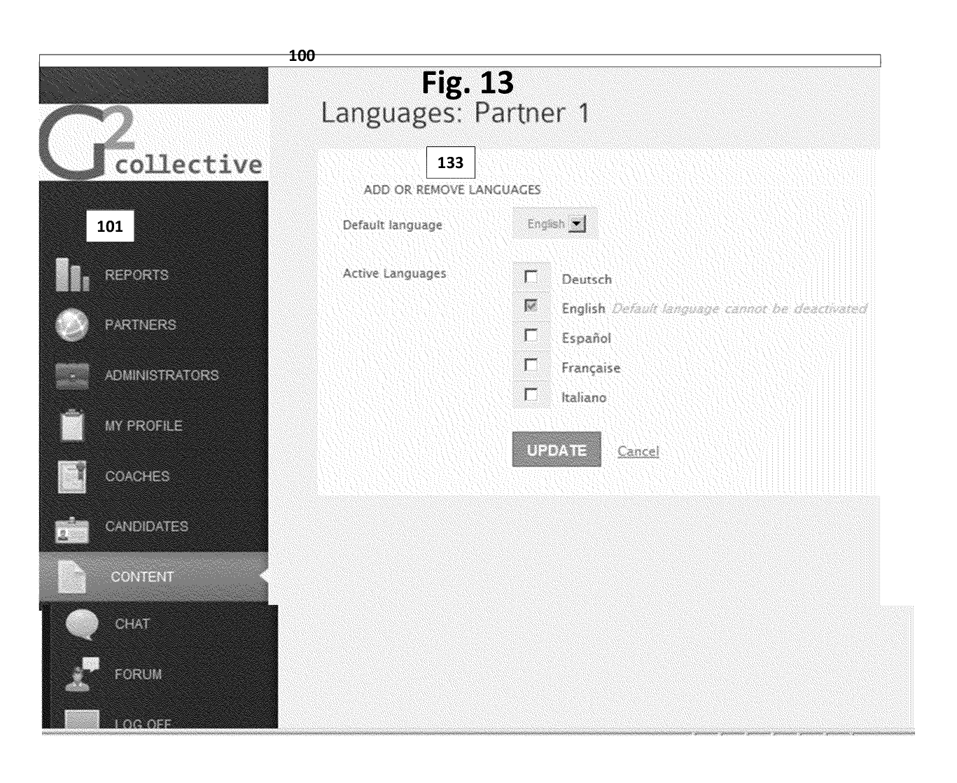

Referring back to FIGS. 12-13, in one embodiment, the course management inputs include a language change input 132 associated with a plurality of different languages, including, but not limited, to English, Spanish, Deutsch, French and Italian. At the language change interface 133, the system receives the language change from the teacher or administrator and automatically translates part or all of the text within the course content from one language to the selected language.

### 3. System—Example C

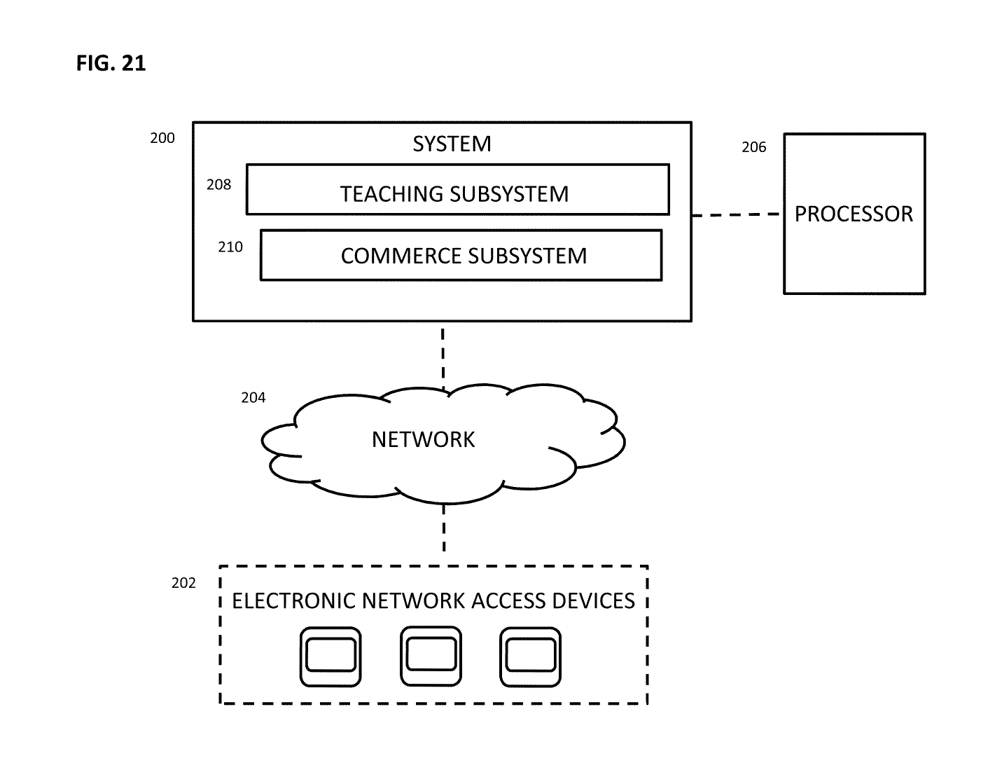

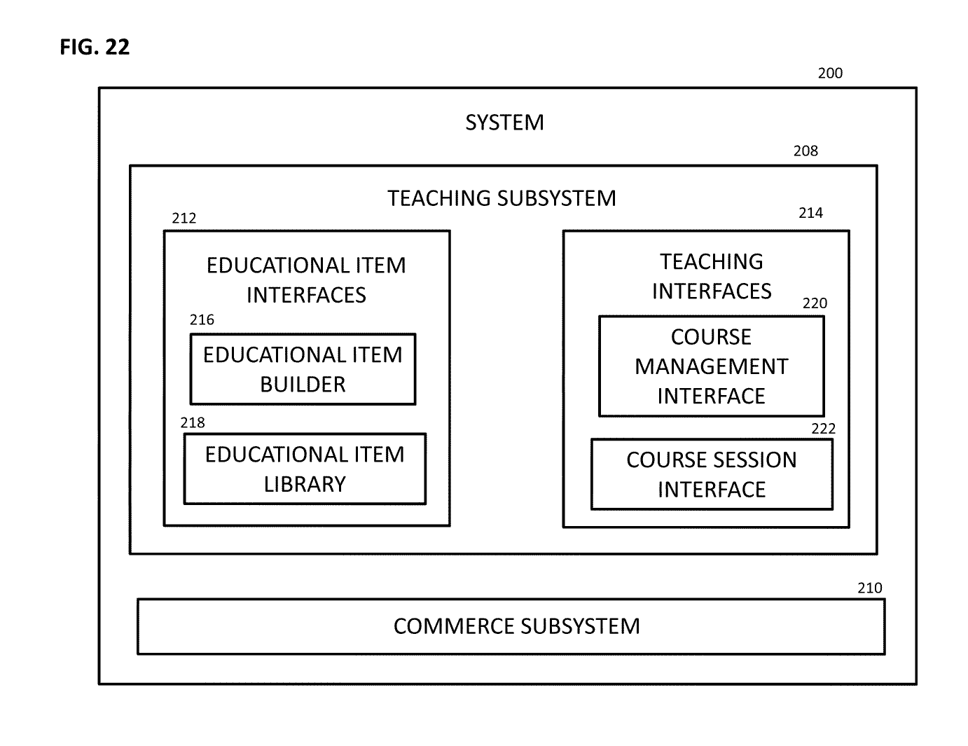

Referring to FIGS. 21-24, in one embodiment, the main system or system 200 is accessible to a plurality of network access devices 202 over an electronic network 204. One or more servers or processors, such as processor 206, operate the system 200. In one embodiment illustrated in FIG. 22, the system 200 includes a teaching subsystem 208 and a marketplace, marketing subsystem or commerce subsystem 210.

In one embodiment, the teaching subsystem 208 includes and incorporates all of the logic, elements, components, functionality, computer-readable instructions, data and structure of the CMS and system 80 described above with respect to FIGS. 1-21.

The term, “system user,” as used below, can include anyone who has a sign-in or login credential for accessing the system 200 over the network 204, including, but not limited to, a teaching party, student, enrollee, attendee or participant. In one embodiment, the system 200 establishes a user account for each system user. The term, “teaching party,” as used below, includes, but is not limited to, an individual (including, but not limited to, an administrator, super administrator, teacher, assistant teacher, instructor, trainer, lecturer, speaker, presenter or other person), an educational institution (including, but not limited to, a university, college, school or clinic), or a not-for-profit entity, company, business, organization, governmental body or any other entity.

The teaching subsystem 208 includes a plurality of educational item interfaces 212 and a plurality of teaching interfaces 214. Once a teaching party registers or otherwise opens an account with the system 200, the system 200 stores an instance or portal of the teaching subsystem 208 designated for that teaching party. Therefore, for each registered teaching party, the system 200 stores the unique data associated with such teaching party's configuration and use of the system 200.

Referring to FIG. 22, the educational item interfaces 212 include an educational item builder 216 which incorporates an educational item builder interface. Also, the educational item interfaces 212 include an educational item library interface or educational item library 218. The system 200 also includes a master educational item library. In one embodiment, the master educational item library is a collection of the public-mode, educational items of all of the libraries 218 of all of the teaching parties.

The teaching interfaces 214 include a course management interface or course manager 220, and the teaching interfaces 214 include a course session interface 222. In one embodiment, the course management interface or manager 220 includes and incorporates the course management interface 100 described above. In one embodiment, the course session interface 222 includes and incorporates the course session interface 114 described above.

### 3.1 Educational Item Builder

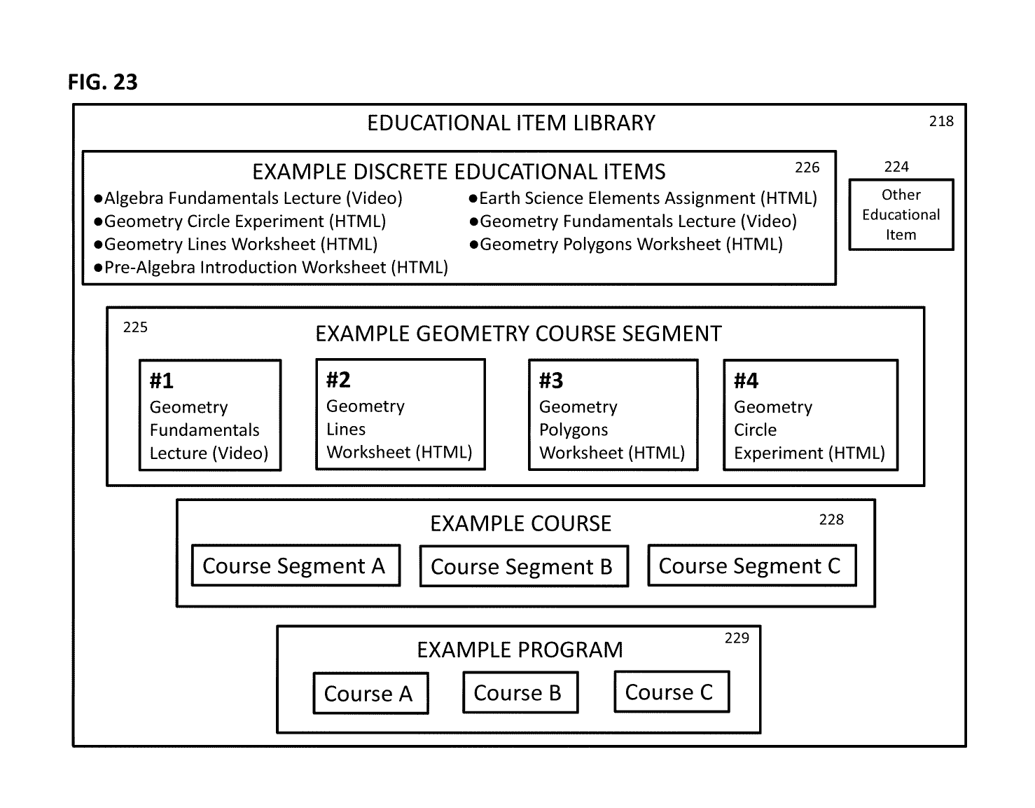

Referring to FIG. 23, a teaching party may use the system 200 to design or build an educational item 224. Educational items 224 can include a variety of items, including, but not limited to: (a) a course segment, a course including a series of course segments, or a program including a plurality of courses; or (b) a discrete item, such as a teaching material, a teaching tool, a teaching aid, a teaching resource, a learning material, a learning tool, a learning aid, a learning resource, a book, a study packet, a worksheet, a test, a quiz, a homework assignment, a course assignment, a form, a survey, a document, a video, an audio recording, a picture or a photograph.

Depending upon the embodiment, an educational item 224 may include a block or course segment, such as the example course segment 225 illustrated in FIG. 23. A course segment, depending upon the embodiment, can include course content related to a designated topic. For example, a course segment for a geometry course can include an audiovisual lecture, in video form, on the topic of polygons. In this example, the video is the educational item. In another example, a course segment for a geometry course can include an assignment worksheet, in HTML form, on the topic of volume calculations. In this example, the HTML worksheet is the educational item.

A course may include a chronological chain of course segments designed to be presented in a designated sequence. In this sense, course segments are like chapters in a book or the weekly topics in a course syllabus. In the example shown in FIG. 23, the teaching party's library already had seven, discrete educational items related to algebra, earth science, geometry and pre-algebra. In this example, the teaching party built the geometry course segment 225 with a desired order for the educational items. As designed by the teaching party, the geometry course segment 225 runs in the order of #1 (Geometry Fundamentals), then #2 (Geometry Lines), then #3 (Geometry Polygons), and then #4 (Geometry Circle).

The system 200 also enables the teaching party to construct or build a course, such as example course 228. As illustrated in FIG. 23, the course 228 includes a plurality of course segments, such as course segments A, B and C. In the example described above, the teaching party could include in his/her course, the geometry course segment 225 along with one or more other course segments. Also, the system 200 enables the teaching party to build an academic program, such as example program 229. As illustrated, the program 229 includes a plurality of courses, such as courses A, B and C. In the example described above, the teaching party could include in a program, the course 228 along with one or more other courses.

In one embodiment, the system 200 is the sole platform which is compatible for the use and operation of educational items 224. In this regard, the educational items 224 are formatted to be nested and operated within the system 200. The system 200 restricts the use of the educational items 224 outside of the system 200. In one embodiment, the educational items 224 are formatted to have a security format or system-specific format. The system-specific format enables the system 200 to run or deploy the educational items 224 within the course session interface 222. At the same time, the system-specific format renders the educational items 224 inoperable outside of the course session interface 222. In another embodiment, the system 200 blocks user access to the source files or data files associated with the educational items 224. In another embodiment, the system 200 impairs the functionality, layout, structure or content of the educational items 224 in response to someone's attempt to export or otherwise extract an educational item 224 from the system 200.

### 3.2 Educational Item Builder

The educational item library 218 of each teaching party, stores the educational items 224 previously created or purchased by such teaching party. If a teaching party wants to create or build a new educational item 224 from scratch, the teaching party may select a “create new educational item” button displayed by the system 200. When the teaching party activates such button, the system 200 displays the educational item builder 216. If a teaching party wants to edit or modify an educational item 224 that is already in the teaching party's library 218, the teaching party may provide a clone or copy input. In response, the system 200 generates a copy of such educational item 224, and the teaching party may proceed to modify that copy using the educational item builder 216.

In one embodiment, the educational item builder 216 enables the teaching party to enter a title, description of content that is covered, and at least one page with content. The educational item builder 216 also enables the teaching party to add objectives for the educational item 224. Objectives can resemble learning objectives of part of a curriculum. It can be another way of providing information not just about what the educational item 224 includes, but what the teaching party intends for the student to have learned after successfully completing the educational item 224.

The educational item builder 216 also enables the teaching party to add identifying information by adding tags to an educational item 224. These tags include identifying words which describe the content or objectives of the educational item 224 and, along with the title, make the educational item 224 searchable by keyword in the educational item library 218. The educational item builder 216 also enables the teaching party to associate a color with the educational item 224. The system 200 displays or graphically represents the educational item 224 as an educational item image, such as a thumbnail background, having the associated color. The educational item image is displayable outside of the educational item builder 216 as described below.

While in the interface of the educational item builder 216, the system 200 enables the teaching party to assign Continuing Education Units (CEUs) to individual educational items 224. In one embodiment, one CEU equals ten hours of coursework time for the student. For each student enrolled in a course run by the system 200, the system 200 tracks the student's CEUs as they are accumulated for each completed educational item 224.

The educational item builder 216 enables the teaching party to create an educational item 224 in one or more human-readable languages, for example, in English and Spanish. In one embodiment, the teaching party builds the educational item 224 in a desired language, such as English. When the teaching party selects one or more translate links in the educational item builder 216, the system 200 automatically generates a translated version of the educational item 224, such as a Spanish version. The educational item builder 216 then enables the teaching party to review the educational item in the desired language and edit the one or more translated versions as desired. For example, the teaching party can replace multimedia content (i.e., videos and pictures) and check for any translation error or nuances in text that may have occurred during the automated translation process.

The educational item builder 216 enables the teaching party to assign or associate different status modes for an educational item 224. In one embodiment, the status modes include “draft,” “in-use,” “private,” and “public.” The draft mode indicates that the educational item 224 is in the process of being built or edited and is not yet available for student use or viewing by other teachers or administrators. An educational item in draft mode is still being developed and edited, and is not yet available for use in courses. Draft mode educational items are only visible to the creating teaching party of the educational item. The in-use mode indicates that the educational item 224 is being used as part of a course session which has active students. In one embodiment, the educational item builder 216 enables the teaching party to edit an in-use educational item 224 in places (such as pages, steps or assignments) which have not yet been accessed by students. The private mode indicates that the educational item 224 is a non-finalized draft or is in-use, and that only the creating teaching party has the permission to use the educational item 224. In such mode, the system 200 prevents another teaching party from viewing another teaching party's educational item which is in private mode. In one embodiment, private mode is the default status when an educational item 224 is published by the teaching party.

The public mode indicates that the educational item 224 has been published by the creating teaching party and is viewable by: (a) system users within, or affiliated with, the teaching party; and (b) existing or future system users who shop at the interface of the commerce subsystem 210. If a shopper purchases an educational item 224, as described below, the shopper can use the educational item builder 216 to edit or customize the purchased educational item 224. As a system user, the shopper can then use the customized, purchased educational item 224 to teach as part of his/her own courses. When an educational item 224 is publicly published, the system 200 sends a warning to the teaching party, alerting the teaching party that other teaching parties with permission will be able to view and duplicate the educational item 224. The system 200 enables the creating teaching party to change the mode status of an educational item from public to private.

In one embodiment, the educational item builder 216 includes a plurality of content pull buttons. The content pull buttons, when selected, open content data sources. In one embodiment, the content data sources include external websites (i.e., Google.com and Amazon.com), external databases and the master educational item library. In one embodiment, the pull buttons include search fields to facilitate the locating of desirable content. In accordance with the legal terms of such websites and databases, the teaching party can pull copies of content and incorporate that content into the educational item 224.

The educational item builder 216 includes a What You See Is What You Get (WYSIWYG) editor, enabling the teaching party to incorporate into the educational item 224, text, images, video files or data files from other websites, such as videos and flash quizzes. In one embodiment, the educational item builder 216 enables the teaching party to incorporate Sharable Content Object Reference Model (SCORM) file packages into the educational item 224. It should be appreciated that an educational item 224 can include any digital content which is viewable over the Internet.

In one embodiment, the educational item builder 216 enables the teaching party to construct the educational item 224 through a series of steps or pages. In this embodiment, the educational item 224 has a page-by-page structure or framework. Each page in an educational item 224 has a data field for a name, and has an optional “info” field for entry of a short description of the page content. The system 200 displays the short description on the interactive syllabus of the course offered by the teaching party. The educational item builder 216 enables the teaching party to edit and reorder the pages within the educational item 224 as described above with respect to FIG. 23.

In one embodiment, a page of an educational item 224 can incorporate a homework assignment. For example, the page can include an assignment retrieval link and an assignment submission link. If a student selects the assignment retrieval link, the system 200 enables the student to download a worksheet in PDF-fillable format. If the student selects the assignment submission link, the system 200 enables the student to upload his/her completed worksheet. In another embodiment, the page itself contains the homework worksheet form. The student can enter answers in the empty fields and select a submit button to submit the completed worksheet to the teaching party.

In another embodiment, a page of an educational item 224 can incorporate a quiz or test. In this embodiment, the educational item builder 218 includes test builder functionality to facilitate the construction of a quiz or test. Depending upon the embodiment, quizzes and tests can either be embedded within an educational item's page or stand alone within the educational item 224. In one embodiment, the educational item builder 218 enables the teaching party to set a test timer. The test timer establishes a set time limit in which the student must complete a test or quiz. The educational item builder 218 also includes a randomization setting, which, if selected, causes the system 200 to randomly present different test or quiz questions to the students.

The educational item builder 218 also includes a grading setting, enabling the teaching party to select automatic or random grading. If the teaching party selects automatic grading, the system 200 automatically grades the quizzes and tests completed by the students. For tests with both a multiple choice section and a short answer section, the teaching party may select a hybrid grading setting. In such case, the system 200 automatically grades the multiple choice section, and the teaching party manually grades the short answer section. When building a test or quiz with the educational item builder 218, the teaching party can include a variety of types of questions, including, but not limited to, (a) true/false; (b) multiple choice (single answer); (c) multiple choice (multi answer); (d) matching; (e) fill in the blank (short text); (f) essay (long text); and (g) document upload.

The educational item builder 218 also enables the teaching party to choose when and where on an educational item's page to require interactions between any combination of teacher and student, teacher and students, students collectively or in work groups. The teaching party can also select from a variety of modalities for these interactions, including, but not limited to, webinars, group document collaboration, one-on-one or group video or text chat. Students, when submitting assignments requested by the teaching party, also have a variety of modality options, and their assignments can be submitted using text, pictures, videos and embedded code. The teaching party can provide feedback through this same array of modalities. In one embodiment, such method of learning interaction is associated with, or otherwise incorporates, the Socratic and Harkness interactive teaching methods.

In one embodiment, the educational item builder 216 includes a preview button. As the teaching party builds the educational item 224, the teaching party can select the preview button. In response, the system 200 displays individual pages or the full educational item 224 as a student would see it. The educational item builder 216 displays a popup window, showing the educational item 224 as a sample within the course session interface 222.

As the educational item is built, the educational item builder 216 generates an educational item information page which shows the educational item's identifying information including the description, objectives, tags, one or more authors or creating teaching parties, the CEUs assigned, if any, date published within the master educational item library, and a list of page names and reference to where course assignments exist within the educational item. The educational item information page also lists any other versions, including cloned and edited versions, of the educational item which may exist. This educational item information page is viewable by clicking on a properties link or an information link within the creator teaching party's library 218, the master educational item library and the commerce interface 211.

In one embodiment, the educational item builder 216 includes a reference generator. The teaching party can provide one or more inputs associated with the reference generator settings. In response, the system 200 automatically generates citations or references to works of others which are copied and incorporated into the educational item 224. The works of others can include, but are not limited to, works of authorship or materials derived from the web or external sources. In this regard, the reference generator can automatically insert into the educational item 224, reference citations for bibliography purposes. In one embodiment, the reference generator can also generate acknowledgements of contribution by contributors of ideas incorporated into the educational item 224.

In one embodiment, the educational item builder 216 includes a direct media streamer. The direct media streamer enables the teaching party to place streamer links within desired locations in pages of the educational item 224. The streamer links can provide links to live or recently populated content from online data sources related to news, current events and other topics. When the student selects one of the streamer links, the system 200 activates the associated stream by, for example, playing a live video or playing an audiovisual news feed (i.e., RSS or Google alerts). In one embodiment, the educational item builder 216 includes an approval setting. The approval setting enables the teaching party to review content based on a periodic automatic search and approve it for integration into the educational item 224.

It should be appreciated that teaching parties can build educational items 224 for other purposes, such as to generate customized media templates or surveys to be attached to a course. In one embodiment, the educational item builder 216 includes a survey builder. The survey builder enables the teaching party to create a variety of types of surveys, including, but not limited to, demographic forms, student-teacher evaluations, course evaluations and committee-teacher evaluations based on standard frameworks. Survey question types include, but are not limited to, rating scales, multiple choice and short answers. In addition, the system 200 includes a survey reporting function, providing the survey outputs or results to the teaching party. The reports can include a variety of selectable formats, including, but not limited to, visual charts and graphs or raw answer data.

In one embodiment, the educational item builder 216 includes a template builder. The template builder enables the teaching party to incorporate or create a variety of types of templates, including, but not limited to, custom-coded media templates which fit within the educational item 224 and templates built within the educational item builder 216. Templates can include special features such as SCORM file packages, live media streaming templates, blogs, and social media feeds to aid in activities such as polls and crowdsourcing for open courses within the marketplace or commerce subsystem 210.

### 3.3 Library Manager

An educational item 224 within an educational item library 218 or the master educational item library, has one of the status modes described above. In one embodiment, the system 200 restricts the use of any educational item 224 to a single session of a course. In such embodiment, the system 200 assigns and stores a unique item identification for each instance of an educational item 224. To use an educational item 224 already in use, a teaching party must replicate it into a child educational item, cloned educational item or edited educational item. The teaching party may then publish the replicated educational item 224 to reduce the disturbance of student activity in the course in which the educational item 224 is being used.

In one embodiment, the system 200 includes a library sharing configurator. The library sharing configurator enables teaching parties to configure their settings for combined library access. In one example, a teaching party is a university X with departments A and B. Department A has professors A1 and A2. Department B has professors B1 and B2. Continuing with this example, another teaching party is college Z with professors Z1 and Z2. In this example, these teaching parties can establish a shared library 218 for sharing between any combination of the following: university X, university X's department A, university X's department B, each of university X's professors A1, A2, B1 and B2, college Z, and each of college Z's professors Z1 and Z2. If these teaching parties are affiliated with each other, they can setup their library settings so that desired shared libraries are viewable by desired teaching parties. For example, professors B2 and Z1 may set their settings so that they can view one another's library or so that they can view a combined library which includes the libraries of both of them. In another example, university X and college Z can appoint each other with joint administrator or librarian privileges, enabling both teaching parties to view one another's library or so that they can view a consortium or combined library which includes both of their libraries. In one embodiment, the settings enable the affiliated teaching parties to see the educational items in one another's library regardless of whether the educational items are marked as public or private.

In one embodiment, the system 200 charges or otherwise brokers a consortium licensing fee for participation in a consortium or combined library. In this regard, each participating teaching party pays a one-time or recurring fee for continued access to the consortium library. In one embodiment, the fee is consideration for the right to replicate any and all of the public-mode, educational items 224 within the consortium library. In this sense, the consortium educational item library serves as a private marketplace or private version of the commerce subsystem 210.

### 3.4 Commerce Subsystem

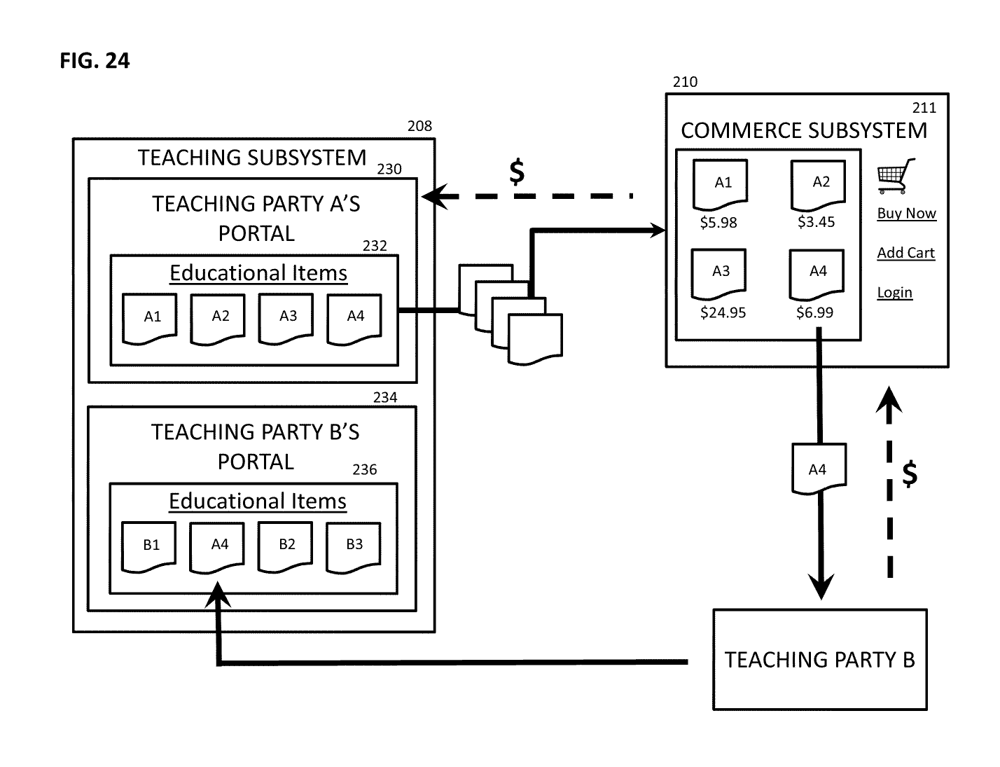

Referring to FIG. 24, the system 200 involves a transactional interaction between the teaching subsystem 208 and the commerce subsystem 210. The commerce subsystem 210 markets educational items 224 which have been assigned the public mode status by their creators or teaching parties. In this way, the system 200 provides teaching parties with a marketing platform or ecommerce marketplace for their educational items 224. In one embodiment, the system 200 enables teaching parties to set prices for their public-mode educational items 224. Any shopper, including a system user or a non-system user of the public, can visit the commerce interface 211 of the commerce subsystem 210. In one embodiment, to purchase an educational item, the shopper must open a shopping account by creating a login credential, such as a username and password. After doing so, the shopper can purchase one or more of the listed educational items using a credit card or other payment method. After purchasing an educational item, the shopper can access the educational item by logging-in to the system 200. In one embodiment, the shopping account login credential is operable for logging into the system 200. Once logged into the system 200, the teaching party can configure its new system account, access the purchased educational item and use the purchased educational item in a course run through the system 200.

In the example illustrated in FIG. 24, a teaching party A has a system portal 230. Within system portal 230, teaching party A's library 232 includes educational items A1, A2, A3 and A4. In this example, teaching party A has previously created or otherwise built these educational items, and teaching party A uses them in her courses. Continuing with this example, teaching party A sets the status mode of these educational items to “public” as described above. The commerce interface 211 displays or graphically identifies the educational items A1, A2, A3 and A4. The commerce interface 211 also displays the prices for the educational items as shown in this example. Teaching party B has a system portal 234. Within system portal 234, teaching party B's library 236 includes educational items B1, B2 and B3. Teaching party B paid $6.99 to buy educational item A4 at the commerce interface 211.

In one embodiment, the entire $6.99 is paid to teaching party A. In another embodiment, part of the $6.99 is paid to teaching party A, and the rest of the $6.99 is paid to the implementor of the system 200 or its affiliates. After the payment is processed, the system 200 adds a replicate or copy of educational item A4 to the library 236 of teaching party B, as shown. Teaching party B then customizes educational item A4 for his purposes and includes it as the second step within his course. In this example, his course flows from B1 to A4 to B2 to B3.

In one embodiment, the system 200 enables the teaching party to set different prices for an educational item. The prices are associated with different license rights or permissions. In this embodiment, the teaching party may set a standard price for a standard license or a premium price for a premium license. The premium price is higher than the standard price. The standard license grants the buyer the right to use the educational item, modify the educational item, and use the modified educational item within the system 200. The standard license excludes the right to sell the modified educational item. The premium license, however, grants the buyer all of the rights of the standard license in addition to the right to sell the modified educational item within the system 200.

In this embodiment, the commerce interface 211 displays the two prices adjacent to the applicable educational item. For example, the commerce interface 211 can display an image or name of a course segment, Spanish XYZ, accompanied by “$12.95 Standard License” and “$22.95 Premium License.”

In one embodiment, the premium license includes a legal condition or restriction. The restriction requires the buyer to obtain the seller's approval before selling a modified version of the seller's original educational item. In one embodiment, the restriction includes an approval procedure controlled by the system 200. Under the procedure, the buyer must first provide the seller with a copy of the modified educational item. The seller has a designated time period, such as thirty days, to disapprove of the modified educational work. If the seller does not provide his/her disapproval within such period, the system 200 releases the modified educational item for sale and marketing by the buyer. If, however, the seller does disapprove of the modified educational work within such period, the system 200 blocks the marketing of the modified educational item. The buyer may revise the modified educational work and resubmit it to the seller for another consideration for approval.

In one embodiment, the system 200 limits the compensation to the original creator to the price paid to the original creator. Put another way, the system 200 excludes the original creator from compensation based on downstream sales. For example, creator Jones sells standard and premium licenses for her Speech XYZ course segment. Creator Thomas buys the premium license and creates a modified version of the segment, Speech XYZ-T. Thomas sells standard and premium licenses for his Speech XYZ-T. The system 200 blocks Jones from receiving any part of the prices paid to Thomas for his standard and premium licenses.

In another embodiment, the system 200 does permit and facilitate compensation based on downstream transactions. In such embodiment, the system 200 enables the original creator to receive a royalty compensation based on downstream sales. For example, creator Dawson sells standard and premium licenses for his Music XYZ course segment. Creator Harris buys the premium license and creates a modified version of the segment, Music XYZ-H. Harris sells standard and premium licenses for her Music XYZ-H. System 200 allocates a percentage, for example, ten percent, of the price in each sale made by Harris. The system 200 pays the percentage as a royalty to Dawson, and Harris receives the sales price less the royalty.

In one embodiment, the system 200 enables teaching parties to market entire courses on the commerce interface 211. Here, the teaching parties specify prices for the courses. Shoppers can include teachers or students. If a student purchases a course, the system 200 automatically enrolls the student and establishes a system user account for the student. If a teacher purchases a course, the system 200 automatically registers the teacher and establishes a system user account for the teacher.

In one embodiment, the system 200 tracks the authorship history of the educational items 224 and courses marketed through the commerce subsystem 210. The commerce interface 211 displays the authorship history to the shoppers. For example, the history may display the following for an educational item: 1^{st}: Author D, 2^{nd}: Author R, 3^{rd}: Authors Y and T; and 4^{th}: Author Q, where author Q created the most recent version of the educational item.

In one embodiment, the commerce interface 211 has the following sections:

(1) a portfolio section which enables shoppers to view the portfolios of the teaching parties who are selling license rights to their educational items and courses;

(2) a course catalog section which enables shoppers to view course catalogues of the marketed courses;

(3) an educational item catalog section which enables shoppers to view catalogs of the marketed educational items;

(4) a teacher evaluation and rating section which: (a) enables visitors to submit surveys to rate teachers who offered marketed courses; and (b) displays the ratings to shoppers;

(5) a content rating section which: (a) enables visitors to submit surveys to rate overall content quality of an educational item or course; and (b) displays such ratings to shoppers; and

(6) a course schedule section which displays schedules related to marketed courses.

In one embodiment, the commerce subsystem 210 includes sorting algorithms operable to sort content based on system user preferences, including, but not limited to, recommended educational items and courses based on interests and similarities to previous purchases, highest rated educational items, topics of interest, teachers of interest, authors of interest, and recently added educational items and courses. In addition, the commerce subsystem 210 includes a transaction section which processes, and reports on, the purchase transactions. In one embodiment, for each shopper account, the transaction section displays the history of purchases. In addition, the system 200 displays compensation information to the marketing teaching parties, including payment amounts or royalties and any transactional deductions, such as processing fees.

It should be understood that, in one embodiment, the system 200 does not include the commerce subsystem 210. In such embodiment, a third party provides an external ecommerce website which is similar to the commerce subsystem 210. For example, an electronic retailer website, such as Amazon.com, could fulfill the function of the commerce subsystem 210.

### 3.5 Course Manager

The system's course management interface or course manager 220 enables a teaching party to build and manage a course. Like an educational item 224, a course is designated to have a title and description, as well as tags (i.e., keywords) to provide a course identity. The teaching party can also add a picture as visual identity for the overall course concept.

A course can exist based on a single educational item 224, or a course can include a group or series of educational items 224. Within the educational item builder 216, described above, the teaching party can search the master educational item library for either the teaching party's own personal educational items 224 or educational items 224 authored by others who have granted the teaching party with access permission. The teaching party can then select individual educational items 224 and drag and drop them into the educational item builder 216. There, the teaching party can reorder the educational items and fuse them together as a block or chain of educational items, creating a full course.

The system 200 also enables the teaching party to associate designated electronic books or e-books with a course segment or course. In one embodiment, the system 200 enables the teaching party to display or identify a required, recommended or designated e-book at the course session interface 222. In one embodiment, the interface 222 displays an e-book link accessible by the students to order the designated e-book. In another embodiment, the system 200 enables the teaching party to incorporate electronic books or e-books into an educational item 224 to supplement the content. The teaching party can select e-books and add purchase link information to a page of an educational item 224. In such embodiment, the system 200 is linked to an external e-book viewer service for students and teaching parties, as well as the interactive syllabus.

Educational items 224 within courses can be completed in either sequential or random order depending on the teaching party's preference. The course, or an educational item within the course, can be specified to be completed within certain dates, such as within a term period, or the timeline can be asynchronous with no end dates. In either case, the system's course manager 220 enables the teaching party to assign a term to the course. The term can be a measure of academic timing such as a quarter, a semester, or a trimester as determined by the teaching party administrators when the course is published. The course manager 220 enables the teaching party to assign a course to multiple terms so that different groups of students can complete the course over different specified time periods and have assignment due dates unique to the term within which they are taking the course. The course manager 220 also enables the teaching party to assign completion dates to assignments, pages and educational items 224 when the educational items 224 become part of a course and a term. When dates are assigned, the course manager 220 automatically synchronizes them with the system's calendar, notification system and interactive syllabus for all participants.

In one embodiment, the course manager 220 enables a teaching party to specify, and save, a course status as “draft” or “in-use” from within the course manager 220. Here, the draft course status indicates that the teaching party has not published the course for students to participate. The in-use course status indicates that the course has been publicly published and that students have gained access with login information. In one embodiment, the system 200 enables authorized teaching parties to edit course content while students are active within the course as long as students have not yet accessed the course content that is to be edited. In this embodiment, once a student accesses content on a page within an educational item 224, such content is no longer editable for that course.

After a course has started, the course manager 220 enables the teaching party to add educational items 224 to the course that have not yet been accessed by students. The course manager 220 enables the teaching party to reorder un-accessed educational items 220 as long as they do not interfere with the order of the educational items 224 that have been accessed by one or more students.

If a teaching party wants to build course content over a period of time, while a course is in use, the course manager 220 enables the teaching party to open and close educational item access to students. This controls when educational items 224 within a course can be accessed, enabling the teaching party to preserve the option to edit such educational items 224. In one example, a teaching party plans to teach a ten-week course and will eventually take the students through ten educational items 224, however on the course launch date, the teaching party has only completed building five of the educational items 224. To preserve the ability to continue to append educational items 224, the teaching party can close the fifth educational item 224 to students until the teaching party has appended a sixth educational item 224 and so forth. In another example, a teaching party wants to edit content frequently until shortly before the teaching party gives access to a student. The course manager 220 enables the teaching party to lock all educational items 224 that are to occur after the current educational item 224 accessed by the students. The lock remains in place until the teaching party is ready to release the next educational item 224 or series of educational items 224. This lock functionality also enables the teaching party to keep the students working at the same pace, blocking them from skipping ahead in content and assignment completion.

The course manager 220 enables the teaching party to assign students to courses either individually or as part of a group. In one embodiment, to assign a group to a course, the teaching party selects all current members of that group and assigns the course to them.

In one embodiment, the system 200 enables the teaching parties to designate a system user with super administrative privileges. This system user, or super administrator, can register a course to have Standard Accreditation or CEU Accreditation. The course manager 220 displays two accreditation links or buttons for these two accreditation options. If the teaching party wants to assign accredited credits or CEUs to a course, the teaching party can select the desired button. The system 200 will then send a request to the super administrator, and the super administrator can enable the accreditation option requested.

Once a teaching party's course is enabled for Standard Accreditation, the course manager 220 provides the option of setting courses as “Accredited” or “Non Accredited.” If accredited, the teaching party can set the number of credit hours that are awarded upon successful completion of the course. The credit hours are displayed to the students in their timelines and course histories, as well as their portfolios, if the students choose to display them.

Teaching parties also have the option of enabling CEUs and setting the number of units awarded for an educational item. When educational items 224 with CEUs are added to a course, the course will be worth the sum of all educational item CEUs. For example, one CEU can be worth ten hours of coursework. If CEU Accreditation is enabled, teaching parties can also set educational item CEUs as “Accredited.” The system 200 separately tracks Accredited and Non-Accredited CEUs within the reporting subsystem of the system 200.

Students can be assigned to a CEU-enabled course which supports a certification or certain number of training hours, or programs that must be completed within a certain time period and possibly repeated if not completed within such time period. In such case, the teaching party can select a date for a renewal reminder to be sent to the instructor, administrators or students. When the renewal date occurs, the instructor or administrator can decide whether the students must repeat the program or course in a new semester, or the instructor or administrator can assign them to a different program or course. It should be understood that a program can consist of multiple courses offered with specific content, objectives and credits.

The course manager 220 enables the teaching party to assign grades for each test, quiz or assignment in a course. The system 200 can then compile the grades and determine the overall course grade for each student. The system 200 automatically calculates the course grade following completion of all educational items 224, assignments and tests. Each test, quiz and assignment within an educational item 224 can be assigned a percentage of the educational item grade. Each educational item 224 can likewise be assigned a percentage of the overall course grade. The course manager 220 also enables the teaching party to designate weighting percentages within a course or educational item 224, and the percentages add up to one hundred.

In one embodiment, the teaching party manually grades essay and short answer questions, and the system 200 automatically grades true/false, multiple choice, and matching questions as follows:

TABLE A

| Test Format | Grading Method |
|---|---|
| True/False and Multiple | Answers are either completely right or |
| Choice (single answer) | completely wrong, so they are scored either |
| | 0 or 100. |
| Multiple Choice (multi | Each individual option can be either |
| answer) and Matching | correct or incorrect. Each option is scored |
| | 0 or 100, and they are then totaled to |
| | determine the overall answer score. For |
| | example, if there are five options on the |
| | question, and four of them are correct, |
| | the score on the question would be 80 out |
| | of 100. |

The course manager 220 automatically builds the initial interactive syllabus after the teacher enters all necessary information into the course educational item builder of the course manager 220. For each student, the system 200 customizes the interactive syllabus during the student's progress throughout the course. The interactive syllabus has many functions. First, the interactive syllabus provides students with course, assignment, due date and grade information. Second, the interactive syllabus is connected with the grading subsystem, reporting subsystem and course calendar of the system 200. As a result, the system 200 captures all of the data recorded about each student's unique progress in the syllabus. The system 200 then reports that data, in real time, to teachers, administrators and auditors who have access permission. The student timeline shows the student's progress through the course, broken down into progress points, including educational items 224, pages, assignments and other components. Each progress point provides a hyperlink or button to link directly to the content area in question.

In addition, the system 200 displays the following information associated with each interactive syllabus: (a) course and credit information including course name, instructor name, office hours, teacher's assistant name, status, % of course completed, start date and end date (if any), and # of credits and/or CEUs (if any); (b) links to course related e-books; (c) educational item/page/assignment name and description; (d) % of educational item completion; (e) due dates (if any); (f) completion dates (if any); and (g) assigned grades (if any). In one embodiment, this information is displayable through a mouseover popup method. The course session interface 222 displays the interactive syllabus for convenient access by the students.

### 3.6 Educational Item Communication Forum

In one embodiment, each page of an educational item 224 can display a single thread of posts specifically for that page. Here, students and instructors can post comments or questions, and other system users can response to them within such page. This page-specific communication forum provides a discussion space that is dedicated specifically to the content that is covered on that page. Whether it is a video lecture, reading material or an assignment, this communication forum provides a method for students to “raise their hands” and immediately ask questions when they arise. This provides the equivalent of raising a hand in class at the moment a student has a question. Other students can either “like” or respond to the question, and the teacher can respond as well. With this page-specific communication forum, course participants can have content-specific discussions in real time and then save the discussion data in a logical place without having to leave the page and navigate through a general forum with topic threads. This communication forum is linked with the system's notification subsystem for the teacher and student. When someone makes a comment or “likes” a question, the notification subsystem sends a notification to the student or teacher so he/she knows who to respond to and what to answer. In one embodiment, posts on this communication forum are threaded one level deep, allowing responses to the top level posts. Also, upon initial page load in the course session interface 222, the most recent few posts are displayed, and there is a “View More” link to load the next group via AJAX, or load more upon scrolling. In one embodiment, such method of learning interaction is associated with, or otherwise incorporates, the Socratic and Harkness interactive teaching methods.

The system 200 enables instructors and administrators to moderate forum discussions and posts associated with their assigned courses, including the following functions: (a) edit post content; (b) delete post (including any associated attachments); (c) delete thread (including all posts and any associated attachments); (d) lock thread (prevent any further responses or editing of posts or likes/dislikes, except by moderators; and (e) editing of system user-provided content by system users.

### 3.7 Portfolio Manager

The system 200 provides portfolio structures or portfolios for teaching parties and students. A teaching party or student can create a portfolio of his/her work completed through the system 200 and also publish his/her portfolio for public viewing. In one embodiment, the portfolio is similar to a digital interactive resume for work completed online. In one embodiment, the system 200 automatically populates a teaching party's or student's portfolio profile with user profile content, including the following: (a) name; (b) photo/avatar; (c) location (as desired); (d) email address (as desired); (e) phone number (as desired); and (f) about me (such as short biographical section).

In one embodiment, the student portfolio shows course history and previous teachers, and the teacher portfolio shows a list of courses instructed, educational items authored and courses taught. Each portfolio can have a plurality of user-definable fields, such as the following: (a) heading text; (b) rich text content; (c) one or more downloadable documents (i.e., resume or curriculum vitae); (d) allowable file types will match the types used for assignments and forum attachments (i.e., PDF, Word Doc, JPG, PNG and GIF); and (e) a link to an external resource (i.e., website or Facebook profile).

If the system user, a teaching party or student, chooses to allow his/her portfolio to be public, the system generates a unique URL with a format such as the following: http://partner1.example.com/portfolio/john.smith. This URL is based on the slug in the system user profile. The slug can be edited by the system user but must be unique within a given system portal. When changing a system user's slug identifier, the system 200 warns the system user that any existing hyperlinks to the old URL will be broken.

In one embodiment, each section of the portfolio has a URL associated with it that can be used to view either the entire portfolio, or just the biography and the specific section. Additionally, the portfolio framework includes social networking icons which enable the system user to post that URL to different external sites, or to send an email.

Once made public, the portfolio is viewable to general internet traffic, as well as accessible to search engine crawlers. If the public portfolio is disabled, system users within a portal of the system 200 will only see the system user's basic profile information (i.e., name, avatar and other basic information). The portfolio framework also includes an edit panel. The edit panel includes a button or link for the system user to preview and edit his/her portfolio. The system 200 enables teachers to post their portfolios at the commerce subsystem 210 interface. The commerce subsystem 210 enables members of the public to provide ratings and reviews related to the teacher portfolios regarding course instruction and content.

### 3.8 Attendance Tracker

In one embodiment, the course manager 220 includes an attendance tracker. The attendance tracker tracks each system user session to record the amount of time system users are logged into the system 200. In addition, the attendance tracker records and updates attendance for online or offline events. When a system user logs into the system 200, the attendance tracker starts a new database record. In one embodiment, the record includes the following: (a) session ID; (b) system user ID; (c) login timestamp; (d) logout/last activity timestamp; and (e) duration (minutes). If the system user clicks the logout button or link, the trackers uses the time of that click as the stopping point. However, if the system user exits by another method, such as closing the browser window or browser tab, or leaving the page inactive until the session times out, the attendance tracker determines the logout time as the last point in time of activity plus the session duration. In one embodiment, the attendance tracker displays a Javascript warning to alert the system user when the session is nearing timeout.

In one embodiment, the course manager 220 enables teaching parties to create events linked to the course calendar. In such embodiment, the course manager 220 enables the teaching parties to set, and activate, the attendance tracker to require attendance for such events.

In one embodiment, the attendance tracker enables system users to track attendance for both online and offline events. In such embodiment, teaching parties can manually enter or upload the events, or they can import the event data bulk using a designated CSV format. In one embodiment, the CSV format requires the following data fields: (a) event name; (b) brief description; (c) required attendance (boolean); (d) start date/time; and (e) course/semester. The available event attendance statuses include, in one embodiment, the following: (a) present; (b) not present; and (c) excused absence.

### 3.9 User Manager

The system 200, in one embodiment, includes a user manager which has a user management interface. An administrator can include a regular administrator, super administrator, or a partner or consortium administrator. The user manager enables an administrator to create, edit, suspend or delete system users. The user manager also enables an administrator to enter system users individually or by imported system user data in bulk in a flat file format, such as CSV or XML. In one embodiment, the system 200 has the follow designated system user roles: (a) super administrator; (b) partner administrator/librarian; (c) teacher; (d) teaching assistant; (e) student; and (f) guest (used for parents or auditors to view one or more students' course history and grades).

In one embodiment, the system 200 enables the administrator to change the titles of these roles. For example, the administrator can change a role name or title from “teacher” to “coach” or “mentor,” or the administrator can change a role title from “student” to “candidate” or “mentee.” In such example, though the titles have changed, the system users still have the same permissions as the teacher role and student role, respectively.

In one embodiment, the user manager has a set of data fields for a user profile. The required data fields, in one embodiment, include the following: (a) first name; (b) last name; (c) email (used as the login system username); (d) password (assigned automatically upon system user creation and can be changed); (e) system user role; (f) student identifier; (unique within the applicable portal); and (g) slug (for use in the portfolio with an automatically-assigned URL). The optional data fields, in one embedment, include the following: (a) location; (b) phone number; and (c) photo or avatar.

To facilitate the assignment of students to courses and terms, the user manager enables teaching parties and administrators to create user groups. When a teaching party assigns a user group to a course, each current member of that group is assigned. The user manager includes a plurality of group functions, including calendar event sharing and group chat. These group functions can be used to connect a number of system users for communication purposes. For example, a teacher can assign students in a course to groups to specify work groups. This allows for ease of communication within a group. For example, a teacher can send an email to a group by selecting “Group A” from contacts. The system 200 also enables a teacher or administrator to run a report on a sub-group of students within a course. The teacher can then compare performance of one sub-group to another sub-group.

### 3.10 Portal Manager

In one embodiment, when a teaching party, such as a college, creates an account with the system 200, the system 200 designates a separate system portal for the teaching party. Each portal has its own data set based on each system user's configuration settings and data. Each system portal functions as a unique or customizable interface of the system 200. The system portals are separately partitioned or otherwise segregated from each other. In one embodiment, each system portal has full access to all functions of the system 200 which relate to the applicable system user and content.

In one embodiment, the system 200 includes a portal manager. The portal manager enables a super administrator to create, edit, suspend, or archive a system portal. The portal manager enables the super administrator to initially create the administrative system user accounts and name the roles for the new system portal.

In one embodiment, the super administrator can create a custom branded look and feel for the system portal, landing page and login. In one embodiment, the portal manager includes a branding editor. The branding editor enables the super administrator to manipulate the graphics, look and feel through an editor tool and HTML. The branding editor also enables the super administrator to upload data files for logos which can be used throughout the portal, including the portal landing page.

For logo uploads, the branding editor includes a sizing tool for the various administrators to crop their logos as desired. The branding editor provides a plurality of selectable colors or a color palette for the various interface elements. In one embodiment, the customizable elements include the following: (a) outer page background; (b) content area background; (c) header background; (d) navigation background; (e) navigation hyperlink text; (f) page text; (g) hyperlink text; and (h) icons.

The portal manager enables the super administrator to suspend any or all of the system portals. In one embodiment, only the super administrator maintains access to suspended portals. The system 200, in one embodiment, archives and stores all system portals, including all of the associated system user accounts, history files, content and other data. Using the portal manager, the super administrator can access the archived system portals. In one embodiment, to deactivate an entire system portal, a super administrator must first archive it. The portal manager also enables the super administrator to activate an archived system portal and use it again.

### 3.11 Report Manager

The system 200, in one embodiment, includes a report manager having a reporting interface. In one embodiment, the report manager pulls data from the system user accounts related to student performance, teacher performance, system user information, system user history and any additional information. Based on the pulled data, the report manager is operable to generate tables and graphical representations of the data. The report managers includes a plurality of report settings and filters for the selection of data for the reports.

The following is an example of the types of reports that the report manager can generate for teachers and administrators:

(1) overview of up to date task completion for all students in a class (filterable by task type);

(2) overview of everything that has been completed by all students in a course, including educational items 224, educational item pages and assignments;

(3) overview of overdue tasks for all students (filterable by task type);

(4) attendance overview for all students in a class or per student;

(5) overdue tasks for teachers (filterable by task type);

(6) overdue tasks for teacher assistants (filterable by task type);

(7) new system users added over time, including students, teachers and administrators;

(8) system users made inactive;

(9) system users deleted;

(10) grading/performance with student comparison in class;

(11) grading/performance and GPA for a student over time;

(12) grades/performance related to time spent logged-in to the system user account;

(13) identification of at-risk students;

(14) educational item page view activity;

(15) course page view activity;

(16) percentage of students who completed an assignment;

(17) percentage of the number of students currently in each educational item/course;

(18) teacher course history summary;

(19) student course history summary;

(20) comparison of the number of educational items created by teachers/administrators;

(21) comparison of student test taking times;

(22) comparison of current class performance to previous classes with selection of courses or semesters to compare averages;

(23) communication points for each educational item and course with break-down of the number of questions/threads created (from the page-specific communication forum) and the number of answers/replies to threads and questions, reporting on these statistics in comparison to previous semesters, other courses or educational items;

(24) overview of which modules in a course are creating the most dialogue/engagement;

(25) overview of communication points (from the page-specific communication forum) per student in a course, reporting on which students are most engaged;

(26) response time for discussion questions, reporting on the average time between posts and answers on the page-specific communication forum;

(27) number of forum communication questions per educational item, indicating problem sections in a course;

(28) number of form communication questions per page, indicating problem sections in a page of an educational item;

(29) test performance, comparing class averages to past classes;

(30) test performance, comparing students with averages to individuals or student groups and indicating comparison of students to class average;

(31) test performance, showing the average grade per question type;

(32) student-student interaction, showing which students interact most with each other;

(33) student-teacher interaction, showing which students have most interaction with the teacher;

(35) educational item map, showing the child educational items coming from a parent educational item and the authors;

(36) course report, showing all of the courses in which an educational item is used, and if selected, where its child educational items are used as well;

(37) status list of educational items, filterable by teacher or library; and

(38) comparison of student performance on each type of test question.

The following is an example of the types of reports that the report manager can generate for administrators:

(1) a report on which teachers are using which features of the system;

(2) overview of teacher activity, showing overdue tasks for any number of teachers;

(3) overview of student activity, showing overdue tasks for any number of students and comparing number of overdue tasks across courses with different teachers; and

(4) class performance based on history, showing teacher performance and indicating whether a teacher is doing a better or worse job teaching the same course by processing grade averages from past semesters when the same course was taught.

The following is an example of the types of reports that the report manager can generate for guests:

(1) grades and GPA for specific students or student groups, including a table with corresponding information, such as assignments, educational items and courses); and

(2) overview of up-to-date task completion and overdue tasks for specific students or groups, indicating whether a student/student group is keeping up, showing lists and dates with completion or overdue status, and also indicating the level of interaction with the teacher.

The following is an example of the types of reports that the report manager can generate for students:

(1) test results, showing quiz and test results with corrections immediately upon completion of an auto-graded educational item;

(2) total CEUs attempted and total CEUs completed with a table of the corresponding educational items and institutions offering CEUs;

(3) total credits attempted and total credits awarded with a table of the corresponding courses and crediting institutions, including GPA; and

(4) Upcoming, required courses and/or training hours, including the due date for completion.

### 3.12 Method

The operation and function of the system 200 involve a method. In one embodiment, the method includes the following steps:

(a) cause a teacher-related interface to be displayed, wherein the teacher-related interface displays a first educational item library;

(b) receive an educational item building input from a first teaching party, wherein the educational item building input relates to an educational item buildable by the first teaching party, and wherein the educational item is locatable in the first educational item library;

(c) receive a course building input from the first teaching party, wherein the course building input relates to a course offerable to a plurality of students during a session, and wherein the course involves the educational item;

(d) cause a course session interface to be displayed during the session;

(e) in response to a marketing input from the first teaching party, display item information on a commerce interface, wherein the item information is associated with the educational item, and wherein the item information includes a price;

(f) receive a purchase request from a second teaching party;

(g) in response to the purchase request, process a payment provided by the second teaching party;

(h) add a copy of the educational item to a second educational item library of the second teaching party; and

(i) provide compensation to the first teaching party, wherein the compensation is based, at least in part, on the payment received from the second teaching party.

### 4. Electronics and Software

### 4.1 Network

Referring to FIGS. 10 and 21, each network 90 and 204 can be any suitable type of network. Depending upon the embodiment, each network 90 and 204 can include one or more of the following: a wired network, a wireless network, a local area network (LAN), an extranet, an intranet, a wide area network (WAN) (including, but not limited to, the Internet), a virtual private network (VPN), an interconnected data path across which multiple devices may communicate, a peer-to-peer network, a telephone network, portions of a telecommunications network for sending data through a variety of different communication protocols, a Bluetooth communication network, a radio frequency (RF) data communication network, an infrared (IR) data communication network, a satellite communication network or a cellular communication network for sending and receiving data through short messaging service (SMS), multimedia messaging service (MMS), hypertext transfer protocol (HTTP), direct data connection, Wireless Application Protocol (WAP), email or any other suitable message transfer service or format.

### 4.2 Hardware

Referring to FIGS. 10 and 21, in one embodiment, each of the systems 80 and 200 includes a single server. In another embodiment, each of the systems 80 and 200 includes multiple servers, each of which implements a different part of such system. In one embodiment, each of the one or more servers includes: (a) a processor (such as the processor 88 and 206) or a central processing unit (CPU); and (b) one or more data storage devices, including, but not limited to, a hard drive with a spinning magnetic disk, a Solid-State Drive (SSD), a floppy disk, an optical disk (including, but not limited to, a CD or DVD), a Random Access Memory (RAM) device, a Read-Only Memory (ROM) device (including, but not limited to, programmable read-only memory (PROM), erasable programmable read-only memory (EPROM), electrically erasable programmable read-only memory (EEPROM)), a magnetic card, an optical card, a flash memory device (including, but not limited to, a USB key with non-volatile memory, any type of media suitable for storing electronic instructions or any other suitable type of computer-readable storage medium.

In one embodiment, each of the one or more servers is a general purpose computer. In one embodiment, the one or more servers function to deliver webpages at the request of clients, such as web browsers, using the Hyper-Text Transfer Protocol (HTTP). In performing this function, the one or more servers deliver Hyper-Text Markup Language (HTML) documents and any additional content which may be included, or coupled to, such documents, including, but not limited, to images, style sheets and scripts.

The network access devices 92 and 202 can include any device operable to access the networks 90 and 204, including, but not limited to, a server, personal computer (PC) (including, but not limited to, a desktop PC, a laptop or a tablet), smart television, Internet-enabled TV, person digital assistant, smartphone, cellular phone or mobile communication device. In one embodiment, each network access device 92 and 202 has at least one input device (including, but not limited to, a touchscreen, a keyboard, a microphone, a sound sensor or a speech recognition device) and at least one output device (including, but not limited to, a speaker, a display screen, a monitor or an LCD).

### 4.3 Software

In one embodiment, the servers and network access devices each include a suitable operating system. Depending upon the embodiment, the operating system can include Windows, Mac, OS X, Linux, Unix, Solaris or another suitable computer hardware and software management system. In another embodiment, one or more of the network access devices includes a mobile operating system, including, but not limited to, Android, BlackBerry, iOS, Windows Phone and Windows RT.

In one embodiment, each of the network access devices has a browser operable by their processors to retrieve, present and traverse the following: (a) information resources on the one or more servers of the systems 80 and 200; and (b) information resources on the World Wide Web portion of the Internet.

In one embodiment, the computer-readable instructions, algorithms and logic of the systems 80 and 200 (including the computer-readable instructions and logic) are implemented with any suitable programming or scripting language, including, but not limited to, C, C++, Java, COBOL, assembler, PERL, Visual Basic, SQL Stored Procedures or Extensible Markup Language (XML), Python, Ruby or Node.

In one embodiment, the data storage device of the systems 80 and 200 holds or stores web-related data and files, including, but not limited, to HTML documents, image files, Java applets, JavaScript, Active Server Pages (ASP), Common Gateway Interface scripts (CGI), XML, dynamic HTML, Cascading Style Sheets (CSS), helper applications and plug-ins.

In one embodiment, the graphical interfaces or interfaces of the systems 80 and 200 are Graphical System user Interfaces (GUIs) structured based on a suitable programming language. The GUIs include, in one embodiment, windows, pull-down menus, buttons, scroll bars, iconic images, wizards, the mouse symbol or pointer, and other suitable graphical elements. In one embodiment, the GUIs incorporate multimedia, including, but not limited to, sound, voice, motion video and virtual reality interfaces.

Additional embodiments include any one of the embodiments described above, where one or more of its components, functionalities or structures is interchanged with, replaced by or augmented by one or more of the components, functionalities or structures of a different embodiment described above.

It should be understood that various changes and modifications to the embodiments described herein will be apparent to those skilled in the art. Such changes and modifications can be made without departing from the spirit and scope of the present invention and without diminishing its intended advantages. It is therefore intended that such changes and modifications be covered by the appended claims.

Although several embodiments of the invention have been disclosed in the foregoing specification, it is understood by those skilled in the art that many modifications and other embodiments of the invention will come to mind to which the invention pertains, having the benefit of the teaching presented in the foregoing description and associated drawings. It is thus understood that the invention is not limited to the specific embodiments disclosed herein above, and that many modifications and other embodiments are intended to be included within the scope of the appended claims. Moreover, although specific terms are employed herein, as well as in the claims which follow, they are used only in a generic and descriptive sense, and not for the purposes of limiting the described invention, nor the claims which follow.

The invention is claimed as follows:

1. A system comprising:
a data storage device configured to store a plurality of instructions, the instructions being executable by a processor to:
(a) receive an educational item building input from a first teaching party, the educational item building input relating to an educational item buildable by the first teaching party;
(b) include the educational item in a course offerable by the first teaching party in response to a course building input from the first teaching party;
(c) receive a marketing input from the first teaching party, the marketing input relating to the educational item; and
(d) provide compensation to the first teaching party, the compensation being based, at least in part, on payment received from a second teaching party's purchase of a right related to the educational item.

2. The system of claim 1, wherein the educational item includes an item selected from the group consisting of a course segment, teaching material, a teaching tool, a teaching aid, a teaching resource, learning material, a learning tool, a learning aid, a learning resource, a book, a study packet, a worksheet, a test, a quiz, a homework assignment, a course assignment, a form, a survey, a document, a video, an audio recording, a picture and a photograph.

3. The system of claim 1, wherein the right includes a permission selected from the group consisting of: (a) permission to use a copy of the educational item; and (b) permission to modify the copy of the educational item.

4. The system of claim 1, wherein at least one of the instructions is executable by the processor to include a copy of the educational item in a second course offerable by the second teaching party in response to a second course building input from the second teaching party.

5. The system of claim 4, wherein at least one of the instructions is executable by the processor to modify the copy of the educational item in response to a modification input from the second teaching party.

6. The system of claim 4, wherein at least one of the instructions is executable by the processor to: (a) cause a display, the display including an image associated with the educational item and a price associated with the educational item; and (b) receive the payment from the second teaching party.

7. The system of claim 6, wherein the display includes a portfolio of the first teaching party.

8. The system of claim 1, wherein at least one of the instructions is executable by the processor to cause a display of a course management interface and a course session interface.

9. A system comprising:
a data storage device configured to store a plurality of instructions, the instructions being executable by a processor to:
(a) cause a teacher-related interface to be displayed, the teacher-related interface displaying a first educational item library;
(b) receive an educational item building input from a first teaching party, the educational item building input relating to an educational item buildable by the first teaching party, the educational item being locatable in the first educational item library;
(c) receive a course building input from the first teaching party, the course building input relating to a course offerable to a plurality of students during a session, the course involving the educational item;
(d) cause a course session interface to be displayed during the session;
(e) in response to a marketing input from the first teaching party, display item information on a commerce interface, the item information being associated with the educational item, the item information including a price;
(f) receive a purchase request from a second teaching party;
(g) in response to the purchase request, process a payment provided by the second teaching party;
(h) add a copy of the educational item to a second educational item library of the second teaching party; and
(i) provide compensation to the first teaching party, the compensation being based, at least in part, on the payment received from the second teaching party.

10. The system of claim 9, wherein the educational item includes an item selected from the group consisting of a course segment, teaching material, a teaching tool, a teaching aid, a teaching resource, learning material, a learning tool, a learning aid, a learning resource, a book, a study packet, a worksheet, a test, a quiz, a homework assignment, a course assignment, a form, a survey, a document, a video, an audio recording, a picture and a photograph.

11. The system of claim 9, wherein the payment is consideration for a right selected from the group consisting of: (a) a right to use a copy of the educational item; and (b) a right to modify the copy of the educational item.

12. The system of claim 9, wherein at least one of the instructions is executable by the processor to include a copy of the educational item in a second course offerable by the second teaching party in response to a second course building input from the second teaching party.

13. The system of claim 12, wherein at least one of the instructions is executable by the processor to modify the copy of the educational item in response to a modification input from the second teaching party.

14. The system of claim 13, wherein the item information includes an image associated with the educational item.

15. The system of claim 9, wherein the commerce interface displays a portfolio of the first teaching party.

16. A method comprising:
electronically storing a plurality of computer-readable instructions; and
electronically executing the computer-readable instructions to:
(a) receive an educational item building input from a first teaching party, the educational item building input relating to an educational item buildable by the first teaching party;
(b) include the educational item in a course offerable by the first teaching party in response to a course building input from the first teaching party;
(c) receive a marketing input from the first teaching party, the marketing input relating to the educational item; and
(d) provide compensation to the first teaching party, the compensation being based, at least in part, on payment received from a second teaching party's purchase of a right related to the educational item.

17. The method of claim 16, wherein the educational item includes an item selected from the group consisting of a course segment, teaching material, a teaching tool, a teaching aid, a teaching resource, learning material, a learning tool, a learning aid, a learning resource, a book, a study packet, a worksheet, a test, a quiz, a homework assignment, a course assignment, a form, a survey, a document, a video, an audio recording, a picture and a photograph.

18. The method of claim 16, wherein the right includes a permission selected from the group consisting of: (a) permission to use a copy of the educational item; and (b) permission to modify the copy of the educational item.

19. The method of claim 16, wherein at least one of the instructions is executable by the processor to include a copy of the educational item in a second course offerable by the second teaching party in response to a second course building input from the second teaching party.

20. The method of claim 19, wherein at least one of the instructions is executable by the processor to modify the copy of the educational item in response to a modification input from the second teaching party.
